(19) United States
(12) Patent Application Publication
(10) Pub. No.: US 2015/0341357 A1
(43) Pub. Date: Nov. 26, 2015

(54) METHOD AND SYSTEM FOR ACCESS CONTROL MANAGEMENT USING REPUTATION SCORES

(71) Applicant: Intuit Inc., Mountain View, CA (US)

(72) Inventors: Brad A. Rambur, Carlsbad, CA (US); William Q. Bonney, San Diego, CA (US); M. Shannon Lietz, San Marcos, CA (US); Luis Felipe Cabrera, Bellevue, WA (US)

(73) Assignee: INTUIT INC., Mountain View, CA (US)

(21) Appl. No.: 14/286,228

(22) Filed: May 23, 2014

(51) Int. Cl. H04L 29/06

(52) U.S. Cl. CPC H04L 63/10

(57) ABSTRACT

Security reputation data associated with a party is obtained and/or monitored. The security reputation data associated with the party is then analyzed to assign a security reputation score to the party. The security reputation score assigned to the party is then used to determine access permissions to be provided to the party. It is then either recommended that the determined access permissions be provided to the party, or the determined access permissions are automatically provided to the party.

### BACKGROUND

As various forms of distributed computing, such as cloud computing, have come to dominate the computing landscape, security has become a bottleneck issue that currently prevents the complete migration of various capabilities and systems associated with sensitive data, such as financial data, to cloud-based infrastructures, and/or other distributive computing models. This is because many owners of sensitive data and resources are extremely hesitant to allow their data and resources to be accessed, processed, and/or otherwise used, by various parties, such as developers, often unknown to the data and/or resource owner.

Consequently, a key security issue is the need to control who, i.e., what parties, are provided access to, use of, and/or control of, various resources owned and operated by an organization. For instance, in order to perform their assigned job or role within an organization, multiple parties within, or associated with, the organization typically require access to various resources owned and operated by the organization that are used to develop, deploy, and/or operate various applications and services.

As an even more specific example, in a cloud computing environment, an organization, such as an enterprise, may have literally thousands, or even tens of thousands, of resources, such as server instances, data storage instances, or other virtual assets, that are provided by a cloud computing environment/infrastructure provider and are under the control of the organization. In many cases, the access to these resources is controlled by multiple accounts assigned to the organization and controlling sub-sets of the resources assigned to the organization. The accounts often are associated with different classes of resources, and/or used for different tasks, and/or with different security issues/levels. In this specific example, in order to perform their assigned job or role within an organization, multiple application developers within, or associated with, the organization will require access to various sub-sets of the virtual assets owned and operated by the organization such as virtual machine or sever instances. However, it is important that each developer only be allowed access to the virtual assets that the developer legitimately needs access to, and it must be determined that each developer has at least the minimum level of trust required for such access.

As discussed above, in a cloud computing environment, an organization can control which resources a given party has access to by controlling the accounts provided to the entity or party. Consequently, by controlling the access to accounts, the organization can control which resources a party can access. In other cases, an organization can similarly control which resources a party can access by controlling the distribution of passwords, passphrases, digital certificates, encryption keys, or other secrets. In many cases, sets of allowed secrets are themselves controlled by other access data such as accounts, access clearance codes, and/or any other access permissions data.

While controlling access to various resources using accounts, secrets, and other access permissions can be an effective way of controlling a party's access to resources, accurately assigning, monitoring, and updating the permissions data which a given party within an organization should, or should not, be provided is currently a manual, and labor intensive, activity that consumes significant resources, and is often handled in an ad-hoc and inefficient manner. In addition, currently, access to resources is largely controlled and monitored at fairly high management levels, thereby consuming high value resources such as the time of senior management. More problematic still is the fact that using current manual methods for assigning, monitoring, and updating permissions data and resource access, there is often no systematic and effective mechanism for monitoring the trustworthiness of a given party and then using the trustworthiness information to assign, monitor, and update the access and permissions data provided to that party. Consequently, using current methods for assigning, monitoring, and updating access and permissions data, there is significant potential for security gaps, human error, and inefficient and ineffective use of resources, including senior management time. In addition, as the volume of data, and entities and parties using data, increases, the current, largely manual, methods for assigning, monitoring, and updating access and permissions data simply can't effectively keep up; thereby increasing the possibility of errors and vulnerabilities.

What is needed is a method and system to objectively determine the security reputation of parties associated with an organization and then use the security reputation data to automate the assignment of access rights and permissions data provided to a party, and/or make recommendations regarding the access rights and permissions data provided to the party.

### SUMMARY

In accordance with one embodiment, a method and system for access control management using reputation scores includes defining one or more security reputation factors to be monitored that are indicative of a party's security related history and activities. In one embodiment, security reputation data associated with a party which represents the party's activities with respect to the one or more security reputation factors is obtained.

In one embodiment, the security reputation data associated with the party is then used to calculate a security reputation score to be associated with the party and the security reputation score associated with the party is used to make a recommendation as to what access to one or more resources provided by an organization associated with the party should be provided to the party.

In one embodiment, the security reputation data associated with the party is used to automatically calculate a security reputation score to be associated with the party and the security reputation score associated with the party is used to automatically provide the party access to one or more resources provided by an organization associated with the party.

### BRIEF DESCRIPTION OF THE DRAWINGS

FIG. 1 is a functional block diagram showing the interaction of various elements for implementing one embodiment;

FIG. 2 is a flow chart depicting a process for access control management using reputation scores in accordance with one embodiment; and

FIG. 3 is a flow chart depicting a process for access control management using reputation scores in accordance with one embodiment.

Common reference numerals are used throughout the FIG.s and the detailed description to indicate like elements. One skilled in the art will readily recognize that the above FIG.s are examples and that other architectures, modes of operation, orders of operation and elements/functions can be provided and implemented without departing from the characteristics and features of the invention, as set forth in the claims.

### DETAILED DESCRIPTION

Embodiments will now be discussed with reference to the accompanying FIG.s, which depict one or more exemplary embodiments. Embodiments may be implemented in many different forms and should not be construed as limited to the embodiments set forth herein, shown in the FIG.s, and/or described below. Rather, these exemplary embodiments are provided to allow a complete disclosure that conveys the principles of the invention, as set forth in the claims, to those of skill in the art.

In accordance with one embodiment, a method and system for access control management using reputation scores includes defining one or more security reputation factors to be monitored that are indicative of a party's security related history and activities. In one embodiment, security reputation data associated with a party which represents the party's activities with respect to the one or more security reputation factors is obtained.

In one embodiment, the security reputation data associated with the party is then used to calculate a security reputation score to be associated with the party. In one embodiment, the security reputation score associated with the party is then associated with that party within the organization regardless of any specific project the party is currently associated with, or any specific activity within a given project that is currently assigned to the party. In one embodiment, the security reputation score associated with the party is then used to determine which access rights and/or permissions data should be provided to the party.

In accordance with one embodiment, a method and system for access control management using reputation scores includes a process for access control management using reputation scores implemented, at least in part, by one or more computing systems.

As used herein, the terms “computing system” and “computing entity”, include, but are not limited to, a virtual asset; a server computing system; a workstation; a desktop computing system; a mobile computing system, including, but not limited to, smart phones, portable devices, and/or devices worn or carried by a user; a database system or storage cluster; a switching system; a router; any hardware system; any communications system; any form of proxy system; a gateway system; a firewall system; a load balancing system; or any device, subsystem, or mechanism that includes components that can execute all, or part, of any one of the processes and/or operations as described herein.

In addition, as used herein, the terms computing system and computing entity, can denote, but are not limited to, systems made up of multiple: virtual assets; server computing systems; workstations; desktop computing systems; mobile computing systems; database systems or storage clusters; switching systems; routers; hardware systems; communications systems; proxy systems; gateway systems; firewall systems; load balancing systems; or any devices that can be used to perform the processes and/or operations as described herein.

In various embodiments, the one or more computing systems implementing the process for access control management using reputation scores are logically or physically located, and/or associated with, one or more computing environments. As used herein, the term “computing environment” includes, but is not limited to, a logical or physical grouping of connected or networked computing systems and/or virtual assets using the same infrastructure and systems such as, but not limited to, hardware systems, software systems, and networking/communications systems. Typically, computing environments are either known environments, e.g., “trusted” environments, or unknown, e.g., “untrusted” environments. Typically trusted computing environments are those where the resources, assets, infrastructure, communication and networking systems, and security systems associated with the computing systems and/or virtual assets making up the trusted computing environment, are either under the control of, or known to, a party. In contrast, unknown, or untrusted computing environments are environments and systems where the assets, components, infrastructure, communication and networking systems, and security systems implemented and associated with the computing systems and/or virtual assets making up the untrusted computing environment, are not under the control of, and/or are not known by, a party, and/or are dynamically configured with new elements capable of being added that are unknown to the party.

Examples of trusted computing environments include the assets and components making up data centers associated with, and/or controlled by, an application and/or any computing systems and/or virtual assets, and/or networks of computing systems and/or virtual assets, associated with, known by, and/or controlled by, an application. Examples of untrusted computing environments include, but are not limited to, public networks, such as the Internet, various cloud-based computing environments, and various other forms of distributed computing systems.

It is often the case that in order to create, and/or deploy, and/or operate an application or service, data must be transferred to, and/or from, a first computing environment that is an untrusted computing environment and a trusted computing environment. However, in other situations a party may wish to transfer data between two trusted computing environments, and/or two untrusted computing environments.

In various embodiments, one or more cloud computing environments are used to create, and/or deploy, and/or operate an application or service that can be any form of cloud computing environment, such as, but not limited to, a public cloud; a private cloud; a virtual private network (VPN); a subnet; a Virtual Private Cloud (VPC); a sub-net or any security/communications grouping; or any other cloud-based infrastructure, sub-structure, or architecture, as discussed herein, and/or as known in the art at the time of filing, and/or as developed after the time of filing.

In many cases, a given application or service may utilize, and interface with, multiple cloud computing environments, such as multiple VPCs, in the course of being created, and/or deployed, and/or operated.

As used herein, the term “virtual asset” includes any virtualized entity or resource, and/or part of an actual, or “bare metal” entity. In various embodiments, the virtual assets can be, but are not limited to, virtual machines, virtual servers, and instances implemented in a cloud computing environment; databases associated with a cloud computing environment, and/or implemented in a cloud computing environment; services associated with, and/or delivered through, a cloud computing environment; communications systems used with, part of, or provided through, a cloud computing environment; and/or any other virtualized assets and/or sub-systems of “bare metal” physical devices such as mobile devices, remote sensors, laptops, desktops, point-of-sale devices, ATMs, electronic voting machines, etc., located within a data center, within a cloud computing environment, and/or any other physical or logical location, as discussed herein, and/or as known/available in the art at the time of filing, and/or as developed/made available after the time of filing.

In various embodiments, any, or all, of the assets making up a given computing environment discussed herein, and/or as known in the art at the time of filing, and/or as developed after the time of filing, can be implemented as virtual assets.

In one embodiment, two or more assets, such as computing systems and/or virtual assets, and/or two or more computing environments, are connected by one or more communications channels including but not limited to, Secure Sockets Layer communications channels and various other secure communications channels, and/or distributed computing system networks, such as, but not limited to: a public cloud; a private cloud; a virtual private network (VPN); a subnet; any general network, communications network, or general network/communications network system; a combination of different network types; a public network; a private network; a satellite network; a cable network; or any other network capable of allowing communication between two or more assets, computing systems, and/or virtual assets, as discussed herein, and/or available or known at the time of filing, and/or as developed after the time of filing.

As used herein, the term “network” includes, but is not limited to, any network or network system capable of allowing communication between two or more assets, virtual assets, and/or computing systems, such as, but not limited to, a peer-to-peer network, a hybrid peer-to-peer network, a Local Area Network (LAN), a Wide Area Network (WAN), a public network, such as the Internet, a private network, a cellular network, any general network, communications network, or general network/communications network system; a wireless network; a wired network; a wireless and wired combination network; a satellite network; a cable network; any combination of different network types; or any other system capable of allowing communication between two or more assets, virtual assets, and/or computing systems, whether available or known at the time of filing or as later developed.

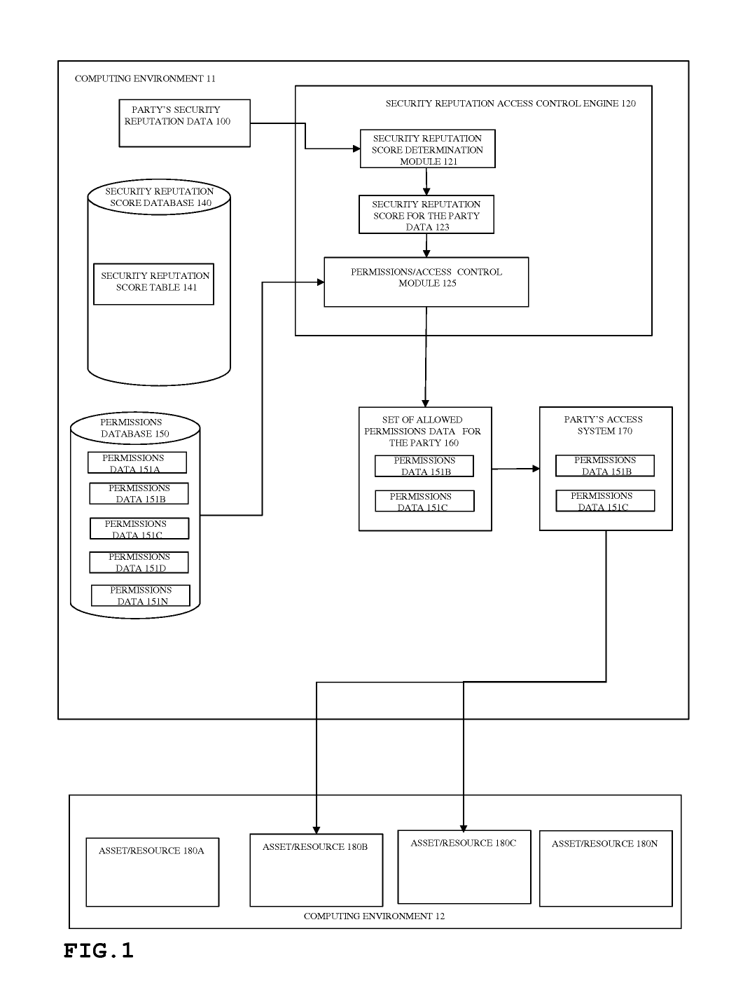

FIG. 1 is a functional diagram of the interaction of various elements associated with one embodiment of the method and system for access control management using reputation scores discussed herein. Of particular note, the various elements in FIG. 1 are shown for illustrative purposes as being associated with specific computing environments, such as computing environment 11 and computing environment 12. However, the exemplary placement of the various elements within these environments and systems in FIG. 1 is made for illustrative purposes only and, in various embodiments, any individual element shown in FIG. 1, or combination of elements shown in FIG. 1, can be implemented and/or deployed on any of one or more computing environments or systems, and/or architectural or infrastructure components, such as one or more hardware systems, one or more software systems, one or more data centers, one or more clouds or cloud types, one or more third party service capabilities, or any other computing environments, architectural, and/or infrastructure components, as discussed herein, and/or as known in the art at the time of filing, and/or as developed/made available after the time of filing.

In addition, the elements shown in FIG. 1, and/or the computing environments, systems and architectural and/or infrastructure components, deploying the elements shown in FIG. 1, can be under the control of, or otherwise associated with, various parties or entities, or multiple parties or entities, such as, but not limited to, the owner of a data center, a party or entity controlling access, permissions, and/or secrets data, a party, and/or entity providing all, or a portion, of a cloud-based computing environment, the owner or a provider of a service, the owner or provider of one or more resources, and/or any other party, and/or entity providing one or more systems, functions, or services, as discussed herein, and/or as known in the art at the time of filing, and/or as made known after the time of filing.

In accordance with one embodiment, one or more security reputation factors are defined and/or determined. In various embodiments, the security reputation factors are representative of a party's security related history and the party's security related activities within an organization.

In various embodiments, the security reputation factors are defined by the organization owning, controlling, and/or utilizing one or more resources to develop, deploy, and/or operate a service or application. In other embodiments, the security reputation factors are defined by other entities, such as a cloud computing infrastructure provider, and/or any other entity or party, as discussed herein, and/or as known in the art at the time of filing, and/or as become known after the time of filing.

In various embodiments, the security reputation factors include, but are not limited to, consideration of a party's historical use of access to one or more resources provided to the party. In one embodiment, this security reputation factor includes an analysis of how a party has used that party's access and permissions in the past. For instance a determination as to whether the party historically has used provided access and permissions judiciously and only as needed to accomplish the task at hand. It is believed this security reputation factor is indicative of a party's respect for security policies and the need to only utilize access and permissions as needed.

In various embodiments, the security reputation factors include, but are not limited to, consideration of the security integrity of code generated by the party. In one embodiment, this security reputation factor includes an analysis of whether or not a party, such as an application developer, has created code and systems that are considered security complaint and have a low number of security vulnerabilities. It is believed this security reputation factor is again indicative of a party's respect for security policies and the party's ability to integrate security consciousness into the party's work product.

In various embodiments, the security reputation factors include, but are not limited to, consideration of the security integrity of code generated by a team supervised by the party. In one embodiment, this security reputation factor includes an analysis of whether or not a party, such as an application development supervisor, has approved, or supervised the creation of code and systems that were considered security complaint and/or had a low number of security vulnerabilities. It is believed this security reputation factor is again indicative of a party's respect for security policies and the party's ability to integrate security consciousness into work product produced under the supervision of the party.

In various embodiments, the security reputation factors include, but are not limited to, consideration of the party's historical use and management of secrets data and adherence to security procedures promulgated by the organization. In one embodiment, this security reputation factor includes an analysis of whether or not a party has historically complied with security and secrets management policies promulgated by the organization. It is believed this security reputation factor is again indicative of a party's respect for security policies and the party's ability to integrate security consciousness into their work.

In various embodiments, the security reputation factors include, but are not limited to, consideration of the historical use and management of secrets data and adherence to security procedures promulgated by the organization by a team supervised by the party. In one embodiment, this security reputation factor includes an analysis of whether or not a team supervised by a party has historically complied with security and secrets management policies promulgated by the organization. It is believed this security reputation factor is again indicative of a party's respect for security policies and the party's ability to integrate security consciousness into the party's team and work supervised by the party.

In various embodiments, the security reputation factors include, but are not limited to, consideration of the security history associated with various hardware and software systems used by the party. In one embodiment, this security reputation factor includes an analysis of whether or not hardware and software, such as desktop and mobile computing systems, under the control of the party, have historically been compromised, or attacked. For instance, has the party ever lost a computing system. It is believed this security reputation factor is again indicative of a party's respect for security and the party's ability to integrate security consciousness into their daily life/activities.

In various embodiments, the security reputation factors include, but are not limited to, consideration of the current, or historical, access and permissions provided to a party. In one embodiment, this security reputation factor includes an analysis of the party's current level of access and permissions and how much potential exposure is associated with the party. Consequently, in various embodiments, the security reputation data associated with the party includes, but is not limited to, job description data indicating the party's job within the organization, and/or initial or default access permissions data required by the job indicated in job description data. It is believed this security reputation factor is not only indicative of a party's current security reputation, but also is an indicator of how much damage could be incurred if the party were to be involved with a security lapse or event.

In various embodiments, the security reputation factors include, but are not limited to, consideration of the record of security events involving a party. In one embodiment, this security reputation factor includes an analysis of the number and types of security events that involved a party, the party's work products, and/or systems used by, and accessed by the party. It is believed this security reputation factor is indicative of the odds the party, or party's work product or systems, will be involved in future security events.

In various embodiments, the security reputation factors include, but are not limited to, consideration of the record of security events involving a team supervised by a party. In one embodiment, this security reputation factor includes an analysis of the number and types of security events that involved a team, or projects, supervised by a party. It is believed this security reputation factor is indicative of the chances a team, or project, supervised by the party, or team's work product or systems, will be involved in future security events.

In various embodiments, the security reputation factors include, but are not limited to, consideration of the party's record of reporting security events associated with the party. In one embodiment, this security reputation factor includes an analysis of how the party reacted to security events that involved the party, and/or a team or project supervised by a party. It is believed this security reputation factor is indicative of how a party will react to any future security events.

In various embodiments, the security reputation factors include, but are not limited to, consideration of the party's use of work product analysis systems, such as static code analysis tools, to check code and systems created by the party. In one embodiment, this security reputation factor includes an analysis of if, and how, the party uses various analysis systems to check, and/or re-check, the party's work product, or work product produced by a team supervised by the party. It is believed this security reputation factor is indicative of how willingly and well a party utilizes tools to check the security integrity of work product.

In various embodiments, the security reputation factors include, but are not limited to, consideration of the types of vulnerabilities in code and systems created by the party discovered by work product analysis systems, such as static code analysis tools. In one embodiment, this security reputation factor includes an analysis of vulnerabilities discovered in the party's work product, or work product produced by a team supervised by the party, using various analysis systems to check, and/or re-check, the party's work product, or work product produced by a team supervised by the party. It is believed this security reputation factor is indicative of how serious potential vulnerabilities in work product created by the party, or under the supervision of the party, are likely to be.

In various embodiments, the security reputation factors include, but are not limited to, consideration of the party's historic response to vulnerabilities in code and systems created by the party, or under the supervision of the party, discovered by analysis systems, such as static code analysis tools. In one embodiment, this security reputation factor includes an analysis of how the party responded to vulnerabilities discovered in the party's work product, or work product produced by a team supervised by the party, and how many times the same or similar vulnerabilities were discovered using various analysis systems to check, and/or re-check, the party's work product, or work product produced by a team supervised by the party. It is believed this security reputation factor is indicative of how well the party is able to respond to, and learn from, mistakes made.

In various embodiments, the security reputation factors include, but are not limited to, consideration of the party's, or a team supervised by the party, historic use and handling of passwords. In one embodiment, this security reputation factor includes an analysis of the party's, and/or team's, use and handling of passwords such as the strength of passwords used by the party, and/or the party's team; if the passwords used by the party, and/or the party's team, conform to a password policy of the organization; how often the party, and/or the party's team, changes/rotates their passwords; whether the passwords used by the party, and/or the party's team, are changed/rotated in accordance with a password policy of the organization. It is believed this security reputation factor is indicative of how much priority the party places on security, and/or how well the party instills a sense of security awareness in teams supervised by the party.

In various embodiments, the security reputation factors include, but are not limited to, consideration of the responsiveness of the party, and/or members of a team supervised by the party, to requests for data and/or action by the party, and/or the party's team, with respect to security. In one embodiment, this security reputation factor includes an analysis of the party's, and/or the party's team, responsiveness to requests for information, and/or change in security policies, by the organization. It is believed this security reputation factor is indicative of how much priority the party places on security and/or how well the party can instill a sense of security awareness in teams supervised by the party.

In various embodiments, the security reputation factors include, but are not limited to, consideration of one or more internal security reputation factors obtained by monitoring the party's activities and interaction with resources within, and/or with, the organization.

In various embodiments, the internal security reputation factors include, but are not limited to, data indicating the party's history of attempted access to resources for which the party did not have the required permissions. In one embodiment, more than a threshold number of attempts by the party to access resources for which the party does not have permission is considered problematic.

In various embodiments, the internal security reputation factors include, but are not limited to, data indicating the party's history of Internet access from the organization's equipment. In one embodiment, the party's use of organizational equipment, such as computing systems, to access the Internet is taken into consideration, including whether the Internet access is deemed to be in connection with the party's role within the organization or of a more personal nature. In various embodiments, a determination that the party is using organizational equipment to access the Internet for personal reasons is considered a potential problem.

In various embodiments, the internal security reputation factors include, but are not limited to, data indicating the party's history of Internet access during the party's working hours. In various embodiments, a determination that the party is accessing the Internet for personal reasons during working hours is considered a potential problem.

In various embodiments, the internal security reputation factors include, but are not limited to, data indicating the party's history of cloud-based resources access using the organization's equipment. In various embodiments, a determination that the party is using organizational equipment to access the cloud for non-project related reasons is considered a potential problem.

In various embodiments, the internal security reputation factors include, but are not limited to, data indicating the party's history of cloud-based resources access during the party's working hours. In various embodiments, log data indicating the party's use of cloud-based resources is monitored to ensure the party is using the cloud-based resources only for tasks associated with the party's role during working hours.

In various embodiments, the internal security reputation factors include, but are not limited to, data indicating the party's history of cloud-based resources access during the party's non-working hours. In various embodiments, log data indicating the party's use of cloud-based resources is monitored to ensure the party is not accessing the cloud during non-working hours.

In various embodiments, the internal security reputation factors include, but are not limited to, data indicating the party's compliance with one or more employment policies. As an example, in one embodiment, data is obtained indicating whether the party turns off computing systems used by the party at the end of the workday, and/or whether the party complies with various organizational security policies.

In various embodiments, the security reputation factors include, but are not limited to, consideration of external security reputation factors obtained by monitoring the party's activities and interaction with resources outside the organization, and/or associated with third party entities.

In various embodiments, the external security reputation factors include, but are not limited to, data obtained from one or more external websites associated with the party, and/or data obtained from one or more accounts with one or more social media websites associated with the party.

In various embodiments, as a condition for being provided employment, and/or access and permissions data, the party is required to provide the organization permission to access, and/or access information related to, various websites, including social media websites, where the party may have an account, and/or presence. In various embodiments, these external websites are monitored to ensure that the party's activities outside of the workplace are in compliance with the organization's security and employment policies. Any indication from the party's presence on the outside websites that the party is engaging in, or supporting, activities that are contrary to the organization's security and/or employment policies is considered problematic.

In various embodiments, as a condition for being provided employment and/or permissions data, the party is requested to provide various information required to access the various external websites. In one embodiment, failure to provide this data, or update this data when it is changed, is considered problematic. In addition, failure to provide the required access data, and/or update the required access data, upon request is also considered problematic. In various embodiments, even when the party fails to provide the required access data, other methods may be employed to obtain the data such as, but not limited to, screen scraping or similar technologies.

In various embodiments, the external security reputation factors include, but are not limited to, data obtained from a web browser used by the party indicating the party's Internet access history and sites accessed by the party using organizational equipment, and/or equipment that is used for organizational access. In various embodiments, data indicating that the party is accessing websites that are considered problematic, and/or contrary to the organization's security and/or employment policy, is considered problematic.

In various embodiments, the external security reputation factors include, but are not limited to, historical geographic location data associated with the party. In various embodiments, computing systems, and particularly mobile computing systems, phones, or other devices, associated with the party, and/or as provided to the party by the organization, are used to track the travel and geographic locations associated with a party. In various embodiments, data indicating that the party has traveled to, or frequents, geographic locations associated with businesses and/or organizations that are considered problematic, such as a competitor of the organization's offices, and/or known geographic locations associated with malicious actors, is considered an indication of the trust level associated with the party.

In various embodiments, the external security reputation factors include, but are not limited to, data obtained from one or more phones associated with the party, such as data indicating phone numbers, text messages, and/or emails, sent, and/or received, by the party. In various embodiments, this data is analyzed to determine if the party is in contact with other parties and/or organizations considered problematic, and/or contrary to, the organization's security and/or employment policies.

In various embodiments, the external security reputation factors include, but are not limited to, data obtained from one or more computing systems associated with the party. In various embodiments, this data is analyzed to determine if the party is in contact with other parties and/or organizations considered problematic, and/or contrary to the organization's security and/or employment policies.

In various embodiments, the security reputation factors include, but are not limited to, consideration of human resources security reputation factors indicating the party's employment and advancement record within the organization.

In various embodiments, the human resources security reputation factors include, but are not limited to, the length of employment of the party by the organization. In various embodiments, the longer the party has been an employee of, and/or associated with, the organization; the higher the level of trust assigned to the party.

In various embodiments, the human resources security reputation factors include, but are not limited to, data indicating the advancement of the party within the organization as compared with similarly situated parties within the organization. In various embodiments, data indicating the party has not advanced within the organization at the same rate as other similarly situated parties within the organization is considered potentially problematic in that this data could be an indication that the party is not particularly happy in their position. In addition, data indicating the party has not advanced within the organization at the same rate as other similarly situated parties within the organization may indicate that management has chosen not to place the same level of trust in the party and advance them at the same rate as other similarly situated parties. Consequently data indicating the party has not advanced at the same rate as other similarly situated parties can be an indication that the trust assigned to the party should be lowered.

In various embodiments, the human resources security reputation factors include, but are not limited to, data reflecting employee review/evaluation data associated with the party. In various embodiments, a poor, or lower than historical, review or evaluation of the party is considered potentially problematic and an indication that the trust of the party should be lowered. Likewise, a good, or higher than historical, review or evaluation of the party is considered an indication that the trust of the party should be raised.

In various embodiments, the human resources security reputation factors include, but are not limited to, the employment history of the party. In particular, data indicating the party has been employed by competitors of the organization, and/or has been subjected to disciplinary action within the organization, and/or by previous employers, is considered potentially problematic and an indication that the trust assigned to the party should be lower.

In various embodiments, the security reputation factors can include any security reputation factors, or combination of security reputation factors, as discussed herein, and/or as known in the art at the time of filing, and/or as become known, or are made available, after the time of filing.

In one embodiment, once the security reputation factors are defined and/or determined, security reputation data associated with a given party is obtained. In one embodiment, the security reputation data associated with a given party represents the party's activities with respect to the one or more security reputation factors.

In various embodiments, the security reputation data associated with the party includes security reputation data obtained from several sources including, but not limited to, log data representing historical access used by the party, and/or one or more members of a team or project supervised by the party; employment records for the party, and/or one or more members of a team or project supervised by the party; a human resources department and/or an accounting department associated with the organization; by monitoring the activities and interaction with resources within, and/or with, the organization of the party, and/or one or more members of a team or project supervised by the party; by monitoring the activities and interaction with resources outside the organization, and/or associated with third party entities, of the party, and/or one or more members of a team or project supervised by the party; log data indicating use and management of secrets data and adherence to security procedures by party, and/or one or more members of a team or project supervised by the party; one or more external websites associated with the party, and/or one or more members of a team or project supervised by the party; one or more social media websites associated with the party, and/or one or more members of a team or project supervised by the party; a web browser used by the party, and/or one or more members of a team or project supervised by the party, indicating Internet access history and sites accessed by the party, and/or one or more members of a team or project supervised by the party, using organizational equipment, and/or equipment that is used for organizational access; one or more phones associated with the party, and/or one or more members of a team or project supervised by the party, such as data indicating phone numbers, text messages, and/or emails, sent, and/or received, by the party, and/or one or more members of a team or project supervised by the party; one or more computing systems associated with the party, and/or one or more members of a team or project supervised by the party; financial data associated with the party, and/or one or more members of a team or project supervised by the party, obtained from public and/or private sources; the party, and/or one or more members of a team or project supervised by the party, via one or more forms and or questionnaires, and/or verbally; and/or from any other source of security reputation data, and using any other methods for obtaining security reputation data, as discussed herein, and/or as known in the art at the time of filing, and/or as becomes known after the time of filing.

In various embodiments, the security reputation data associated with the party is not only initially obtained, but the security reputation data associated with the party is automatically monitored on a periodic, event driven, and/or relatively continuous basis.

FIG. 1 is a functional diagram of the interaction of various elements associated with one embodiment of the method and system for access control management using reputation scores discussed herein. Referring to FIG. 1, party's security reputation data 100 is shown. As discussed below, in one embodiment, party's security reputation data 100 is provided as input data to security reputation score determination module 121 of security reputation access control engine 120.

In one embodiment, the security reputation data associated with the party is processed to generate a security reputation score for the party.

In one embodiment, data representing the party's activities with respect to each of the defined security reputation factors included in the security reputation data associated with the party is individually weighted and processed to generate a security reputation score for the party according to one more algorithms and/or instructions included in one or more memories and implemented by one or more processors associated with one or more computing systems.

In one embodiment, once calculated, the security reputation score for the party is associated with the party in one or more records or databases so that the security reputation score is associated with the party throughout the organization and regardless of any particular project or job description currently assigned to the party. In one embodiment, a security reputation score is calculated for all, or any sub-set, of the employees of the organization.

In one embodiment, the security reputation score associated with the party becomes part of that party's employment record. In one embodiment, the security reputation score associated with the party is used by various supervisors within the organization to determine the eligibility of the party to work on a particular project or to be advanced to a particular job description. In one embodiment, the security reputation score associated with the party is used as a metric for determining the party's advancement, and/or as an employee evaluation tool.

In one embodiment, the security reputation data is processed to generate a security reputation score to be associated with the party by a security reputation access control engine used to generate security reputation scores and/or determine access and permissions data to be provided to the party.

Referring to FIG. 1, in one embodiment, party's security reputation data 100 is provided as input data to security reputation score determination module 121 of security reputation access control engine 120. In one embodiment, at security reputation score determination module 121 various elements in party's security reputation data 100 representing specific security reputation factors are weighted and processed to determine a security reputation score for the party, represented by security reputation score for the party data 123.

As also seen in FIG. 1, in one embodiment, once determined, security reputation score for the party data 123 is provided to security reputation score database 140. In one embodiment, security reputation score databases 140 includes security reputation score table 141 correlating the party's identification data (not shown) with the security reputation score for the party data 123. In one embodiment, security reputation score table 141 includes data correlating party identification data (not shown) for each employee of the organization with the respective security reputation score for the party.

As also seen in FIG. 1, in one embodiment, once determined, security reputation score for the party data 123 is provided as input data to permissions/access control module 125 of security reputation access control engine 120. Permissions access control module 125 of security reputation access control engine 120 is discussed in more detail below.

In one embodiment, the security reputation score associated with the party is used to make a recommendation as to which access rights and/or permissions data should be provided to the party.

In one embodiment, the security reputation score associated with the party is used to make a recommendation as to whether an individual access request made by the party should be granted on a case-by-case basis in response to the received individual access request made by the party.

In one embodiment, the security reputation score associated with the party is used to make a recommendation regarding a set of allowed access and permissions data to be provided to, and associated with, the party; the set of allowed access and permissions data providing the party access to one or more resources.

In one embodiment, the security reputation score associated with the party is calculated and analyzed to recommend specific access, and/or a set of allowed access and permissions data to be associated with the party, at regularly scheduled time intervals. For instance, in various embodiments, on a weekly, monthly, quarterly, or annual basis, and/or at any other time interval defined and/or desired.

In one embodiment, the security reputation score associated with the party is calculated and analyzed to recommend specific access, and/or a set of allowed access and permissions data to be associated with the party, after each job or project change, evaluation, and/or review, of the party, and/or upon the transfer of the party, and/or upon promotion or demotion of the party.

In one embodiment, the security reputation score associated with the party is calculated and analyzed to recommend specific access, and/or a set of allowed access and permissions data to be associated with the party, whenever there is a threshold change in any of the security reputation data associated with the party.

In one embodiment, the security reputation score associated with the party is used to automatically determine whether an individual access request made by the party should be granted on a case-by-case basis in response to the received individual access request made by the party.

In one embodiment, the security reputation score associated with the party is used to automatically provide, and associate, a set of allowed access and permissions data with the party; the set of allowed access and permissions data providing the party access to one or more resources.

In one embodiment, the security reputation score associated with the party is automatically calculated and analyzed to recommend specific access, and/or a set of allowed access and permissions data to be associated with the party, at regularly scheduled time intervals. For instance, in various embodiments, on a weekly, monthly, quarterly, or annual basis, and/or at any other time interval defined and/or desired.

In one embodiment, the security reputation score associated with the party is automatically calculated and analyzed to recommend specific access, and/or a set of allowed access and permissions data to be associated with the party, after each job or project change, evaluation and/or review, of the party, and/or upon the transfer of the party, and/or upon promotion or demotion of the party.

In one embodiment, the security reputation score associated with the party is automatically calculated and analyzed to recommend specific access, and/or a set of allowed access and permissions data to be associated with the party, whenever there is a threshold change in any of the security reputation data associated with the party.

As noted above, in various embodiments, the access and permissions allowed for the party determined by the security reputation score associated with the party includes data providing the party with access to one or more resources.

In various embodiments, the access and permissions allowed for the party determined by the security reputation score associated with the party includes access to one or more accounts which, in turn, provide access to one or more resources.

In various embodiments, the access and permissions allowed for the party determined by the security reputation score associated with the party includes one or more accounts which, in turn, provide access to one or more virtual assets and/or other resources within a cloud computing environment.

In various embodiments, the access and permissions allowed for the party determined by the security reputation score associated with the party includes one or more accounts which, in turn, provide the party the capability to instantiate, and/or boot-up, one or more instances and/or other virtual assets in a cloud computing environment.

In various embodiments, the access and permissions allowed for the party determined by the security reputation score associated with the party includes secrets data required to access one or more resources.

As used herein, the term “secrets” includes any information, credentials, or other devices, necessary to protect, encrypt, and/or access, data, one or more resources, one or more virtual assets, and/or one or more computing systems.

Specific illustrative examples of secrets include, but are not limited to, usernames; passwords; passphrases; encryption keys; digital certificates; multifactor authentication data; accounts; identification numbers; and/or any other information, credentials, data, devices, and/or mechanisms used to protect and control access to various systems, resources, file systems and any other persistent storage, and data, and that are required for such access, as discussed herein, and/or as known/available in the art at the time of filing, and/or as developed/made available after the time of filing.

In one embodiment, the secrets represented by the secrets data provided to the party based on the security reputation score associated with the party are of one or more types, or classifications, of secrets. In various embodiments, the secrets are classified according to the type of resource the secret is used to access. For example, usernames, passwords, and passphrases, necessary to access various applications would be classified as user account access secrets, while digital certificates associated with Secure Socket Layer (SSL) communications channels would be classified as communication secrets, and encryption keys would be classified as encryption secrets.

In addition, the secrets represented by the secrets data provided to the party based on the security reputation score associated with the party can be classified according to the level of security provided by the secrets. For instance encryption keys would be classified as secrets providing a relatively high level of security, with longer encryption keys being classified as secrets providing a higher level of security, while passwords might be classified as secrets providing a relatively moderate level of security, with longer and more diverse passwords being classified as secrets providing a relatively higher level of security.

In addition, the secrets represented by the secrets data provided to the party based on the security reputation score associated with the party can be classified according to whether the secrets provide access to internal resources, such as databases and data in a data center, or access to external resources such as services offered through a cloud or the Internet.

In one embodiment, the different types of secrets are provided by, and/or originate from, different secret sources. In one embodiment, the secrets data representing the different classes of secrets are maintained, at least initially, in separate secret databases, systems, or data stores, and/or in a master secrets database.

Referring back to FIG. 1, in one embodiment, party's security reputation data 100 is provided as input data to security reputation access control engine 120 and security reputation score determination module 121.

In one embodiment, at security reputation score determination module 121 party's security reputation data 100 is processed, and/or subjected to one or more algorithms, to generate security reputation score for the party data 123.

In one embodiment, security reputation score for the party data 123 is provided as input data to permissions/access control module 125 of security reputation access control engine 120.

As seen in FIG. 1, permissions/access control module 125 is provided access to permissions database 150 which includes various forms of permissions data represented as permissions data 151A, permissions data 151B, permissions data 151C, permissions data 151D, through permissions data 151N. As seen in FIG. 1, permissions/access control module 125 then obtains/retrieves a set of allowed access permissions data for the party, shown as set of allowed permissions data for the party 160.

In one embodiment, once the set of allowed access permissions data for the party is obtained/retrieved, a recommendation is made to one or more authorities within the organization to provide the set of allowed access permissions data for the party to the party, e.g., to an access system, and/or account, associated with the party. In one embodiment, pending approval from the one or more authorities within organization, the set of allowed access permissions data for the party is provided to the party, e.g., is provided to an access system, and/or account, associated with the party.

In another, more automated, embodiment, once the set of allowed access permissions data for the party is obtained/retrieved, the set of allowed access permissions data for the party is automatically provided to the party, e.g., is provided to an access system, and/or account, associated with the party, without any further approval or input.

Referring to FIG. 1, once permissions/access control module 125 obtains/retrieves set of allowed permissions for the party data 160, including, in this specific illustrative example, permissions data 151B and permissions data 151C, permissions data 151B and permissions data 151C are provided to party's access system 170 which, in turn, uses permissions data 151B and permissions data 151C to access asset/resource 180B and asset/resource 180C of the set of types of assets/resources including asset/resource 180A, asset/resource 180B, asset/resource 180C, through asset/resource 180N. In the specific illustrative example of FIG. 1, the set of types of assets/resources including asset/resource 180A, asset/resource 180B, and asset/resource 180C, through asset/resource 180N is shown as residing in computing environment 12.

In another, more automated, embodiment, if the party requests access to a resource for which the party does not currently have the required access and permissions data, the security reputation score associated with the party is automatically analyzed to determine if the party should be provided the required access and permissions data, and if a determination is made that the party should be provided the required access and permissions data, the party is automatically provided the required access and permissions data. This analysis and provision of access and permissions data based on the security reputation score associated with the party represents a level of automation requiring little or no organizational input beyond establishing the initial operating parameters.

Using the method and system for access control management using reputation scores discussed herein, actual security reputation data associated with a party is used to calculate a security reputation score to be associated with the party. The security reputation score associated with the party is then associated with that party within the organization regardless of any specific project the party is associated with, or any specific activity within a given project assigned to the party. The security reputation score associated with the party is then used to determine which access rights and/or permissions data should be provided to the party without the need to involve senior management and with little or no wait time.

Consequently, using the method and system for access control management using reputation scores discussed herein, the security reputation of parties associated with an organization is objectively and systematically determined and then used to automate the assignment of access rights and permissions data provided to a party, and/or make recommendations regarding the access rights and permissions data provided to the party.

### Process

In accordance with one embodiment, a method and system for access control management using reputation scores includes defining one or more security reputation factors to be monitored that are indicative of a party's security related history and activities. In one embodiment, security reputation data associated with a party which represents the party's activities with respect to the one or more security reputation factors is obtained.

In one embodiment, the security reputation data associated with the party is then used to calculate a security reputation score to be associated with the party and the security reputation score associated with the party is used to make a recommendation as to what access to one or more resources provided by an organization associated with the party should be provided to the party.

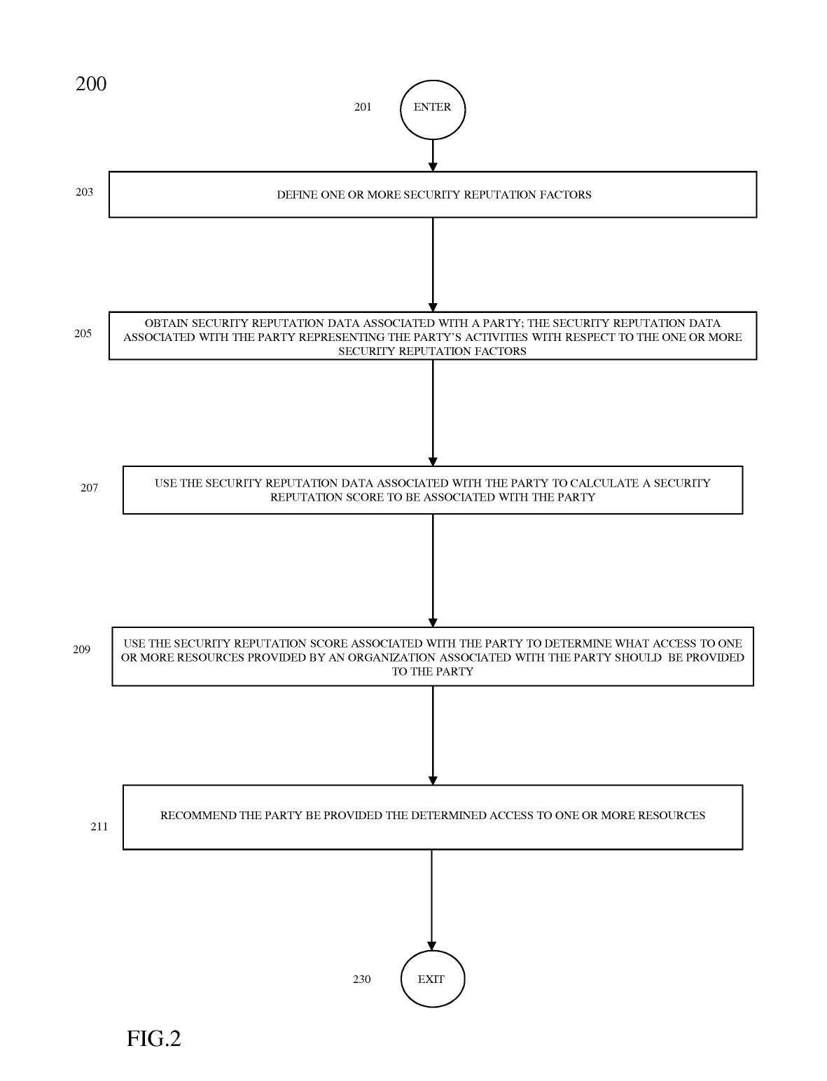

FIG. 2 is a flow chart of a process 200 for access control management using reputation scores in accordance with one embodiment. In one embodiment, process 200 for access control management using reputation scores begins at ENTER OPERATION 201 of FIG. 2 and process flow proceeds to DEFINE ONE OR MORE SECURITY REPUTATION FACTORS OPERATION 203.

In one embodiment, at DEFINE ONE OR MORE SECURITY REPUTATION FACTORS OPERATION 203, one or more security reputation factors are defined and/or determined.

In various embodiments, the security reputation factors of DEFINE ONE OR MORE SECURITY REPUTATION FACTORS OPERATION 203 are representative of a party's security related history and the party's security related activities within an organization.

In various embodiments, the security reputation factors of DEFINE ONE OR MORE SECURITY REPUTATION FACTORS OPERATION 203 are defined by the organization owning, controlling, and/or utilizing one or more resources to develop, deploy, and/or operate a service or application. In other embodiments, the security reputation factors are defined by other entities, such as a cloud computing infrastructure provider, and/or any other entity or party, as discussed herein, and/or as known in the art at the time of filing, and/or as become known after the time of filing.

In various embodiments, the security reputation factors of DEFINE ONE OR MORE SECURITY REPUTATION FACTORS OPERATION 203 include, but are not limited to, consideration of a party's historical use of access to one or more resources provided to the party. In one embodiment, this security reputation factor includes an analysis of how a party has used that party's access and permissions in the past. For instance a determination as to whether the party historically has used provided access and permissions judiciously and only as needed to accomplish the task at hand. It is believed this security reputation factor is indicative of a party's respect for security policies and the need to only utilize access and permissions as needed.

In various embodiments, the security reputation factors of DEFINE ONE OR MORE SECURITY REPUTATION FACTORS OPERATION 203 include, but are not limited to, consideration of the security integrity of code generated by the party. In one embodiment, this security reputation factor includes an analysis of whether or not a party, such as an application developer, has created code and systems that are considered security complaint and have a low number of security vulnerabilities. It is believed this security reputation factor is again indicative of a party's respect for security policies and the party's ability to integrate security consciousness into the party's work product.

In various embodiments, the security reputation factors of DEFINE ONE OR MORE SECURITY REPUTATION FACTORS OPERATION 203 include, but are not limited to, consideration of the security integrity of code generated by a team supervised by the party. In one embodiment, this security reputation factor includes an analysis of whether or not a party, such as an application development supervisor, has approved, or supervised the creation of code and systems that were considered security complaint and/or had a low number of security vulnerabilities. It is believed this security reputation factor is again indicative of a party's respect for security policies and the party's ability to integrate security consciousness into work product produced under the supervision of the party.

In various embodiments, the security reputation factors of DEFINE ONE OR MORE SECURITY REPUTATION FACTORS OPERATION 203 include, but are not limited to, consideration of the party's historical use and management of secrets data and adherence to security procedures promulgated by the organization. In one embodiment, this security reputation factor includes an analysis of whether or not a party has historically complied with security and secrets management policies promulgated by the organization. It is believed this security reputation factor is again indicative of a party's respect for security policies and the party's ability to integrate security consciousness into their work.

In various embodiments, the security reputation factors of DEFINE ONE OR MORE SECURITY REPUTATION FACTORS OPERATION 203 include, but are not limited to, consideration of the historical use and management of secrets data and adherence to security procedures promulgated by the organization by a team supervised by the party. In one embodiment, this security reputation factor includes an analysis of whether or not a team supervised by a party has historically complied with security and secrets management policies promulgated by the organization. It is believed this security reputation factor is again indicative of a party's respect for security policies and the party's ability to integrate security consciousness into the party's team and work supervised by the party.

In various embodiments, the security reputation factors of DEFINE ONE OR MORE SECURITY REPUTATION FACTORS OPERATION 203 include, but are not limited to, consideration of the security history associated with various hardware and software systems used by the party. In one embodiment, this security reputation factor includes an analysis of whether or not hardware and software, such as desktop and mobile computing systems, under the control of the party, have historically been compromised, or attacked. For instance, whether the party has ever lost a computing system. It is believed this security reputation factor is again indicative of a party's respect for security and the party's ability to integrate security consciousness into their daily life/activities.

In various embodiments, the security reputation factors of DEFINE ONE OR MORE SECURITY REPUTATION FACTORS OPERATION 203 include, but are not limited to, consideration of the current, or historical, access and permissions provided to a party. In one embodiment, this security reputation factor includes an analysis of the party's current level of access and permissions and how much potential exposure is associated with the party. Consequently, in various embodiments, the security reputation data associated with the party includes, but is not limited to, job description data indicating the party's job within the organization, and/or initial or default access permissions data required by the job indicated in job description data. It is believed this security reputation factor is not only indicative of a party's current security reputation, but also is an indicator of how much damage could be incurred if the party were to be involved with a security lapse or event.

In various embodiments, the security reputation factors of DEFINE ONE OR MORE SECURITY REPUTATION FACTORS OPERATION 203 include, but are not limited to, consideration of the record of security events involving a party. In one embodiment, this security reputation factor includes an analysis of the number and types of security events that involved a party, the party's work products, and/or systems used by, and accessed by the party. It is believed this security reputation factor is indicative of the odds the party, or party's work product or systems, will be involved in future security events.

In various embodiments, the security reputation factors of DEFINE ONE OR MORE SECURITY REPUTATION FACTORS OPERATION 203 include, but are not limited to, consideration of the record of security events involving a team supervised by a party. In one embodiment, this security reputation factor includes an analysis of the number and types of security events that involved a team, or projects, supervised by a party. It is believed this security reputation factor is indicative of the chances a team, or project, supervised by the party, or team's work product or systems, will be involved in future security events.

In various embodiments, the security reputation factors of DEFINE ONE OR MORE SECURITY REPUTATION FACTORS OPERATION 203 include, but are not limited to, consideration of the party's record of reporting security events associated with the party. In one embodiment, this security reputation factor includes an analysis of how the party reacted to security events that involved the party, and/or a team or project supervised by a party. It is believed this security reputation factor is indicative of how a party will react to any future security events.

In various embodiments, the security reputation factors of DEFINE ONE OR MORE SECURITY REPUTATION FACTORS OPERATION 203 include, but are not limited to, consideration of the party's use of work product analysis systems, such as static code analysis tools, to check code and systems created by the party. In one embodiment, this security reputation factor includes an analysis of if, and how, the party uses various analysis systems to check, and/or re-check, the party's work product, or work product produced by a team supervised by the party. It is believed this security reputation factor is indicative of how willingly and well a party utilizes tools to check the security integrity of work product.

In various embodiments, the security reputation factors of DEFINE ONE OR MORE SECURITY REPUTATION FACTORS OPERATION 203 include, but are not limited to, consideration of the types of vulnerabilities in code and systems created by the party discovered by work product analysis systems, such as static code analysis tools. In one embodiment, this security reputation factor includes an analysis of vulnerabilities discovered in the party's work product, or work product produced by a team supervised by the party, using various analysis systems to check, and/or re-check, the party's work product, or work product produced by a team supervised by the party. It is believed this security reputation factor is indicative of how serious potential vulnerabilities in work product created by the party, or under the supervision of the party, are likely to be.

In various embodiments, the security reputation factors of DEFINE ONE OR MORE SECURITY REPUTATION FACTORS OPERATION 203 include, but are not limited to, consideration of the party's historic response to vulnerabilities in code and systems created by the party, or under the supervision of the party, discovered by analysis systems, such as static code analysis tools. In one embodiment, this security reputation factor includes an analysis of how the party responded to vulnerabilities discovered in the party's work product, or work product produced by a team supervised by the party, and how many times the same or similar vulnerabilities were discovered using various analysis systems to check, and/or re-check, the party's work product, or work product produced by a team supervised by the party. It is believed this security reputation factor is indicative of how well the party is able to respond to, and learn from, mistakes made.

In various embodiments, the security reputation factors of DEFINE ONE OR MORE SECURITY REPUTATION FACTORS OPERATION 203 include, but are not limited to, consideration of the party's, or a team supervised by the party, historic use and handling of passwords. In one embodiment, this security reputation factor includes an analysis of the party's, and/or team's, use and handling of passwords such as the strength of passwords used by the party, and/or the party's team; if the passwords used by the party, and/or the party's team, conform to a password policy of the organization; how often the party, and/or the party's team, changes/rotates their passwords; whether the passwords used by the party, and/or the party's team, are changed/rotated in accordance with a password policy of the organization. It is believed this security reputation factor is indicative of how much priority the party places on security, and/or how well the party instills a sense of security awareness in teams supervised by the party.

In various embodiments, the security reputation factors of DEFINE ONE OR MORE SECURITY REPUTATION FACTORS OPERATION 203 include, but are not limited to, consideration of the responsiveness of the party, and/or members of a team supervised by the party, to requests for data and/or action by the party, and/or the party's team, with respect to security. In one embodiment, this security reputation factor includes an analysis of the party's, and/or the party's team, responsiveness to requests for information, and/or change in security policies, by the organization. It is believed this security reputation factor is indicative of how much priority the party places on security and/or how well the party can instill a sense of security awareness in teams supervised by the party.

In various embodiments, the security reputation factors of DEFINE ONE OR MORE SECURITY REPUTATION FACTORS OPERATION 203 include, but are not limited to, consideration of one or more internal security reputation factors obtained by monitoring the party's activities and interaction with resources within, and/or with, the organization.

In various embodiments, the internal security reputation factors of DEFINE ONE OR MORE SECURITY REPUTATION FACTORS OPERATION 203 include, but are not limited to, data indicating the party's history of attempted access to resources for which the party did not have the required permissions. In one embodiment, more than a threshold number of attempts by the party to access resources for which the party does not have permission is considered problematic.

In various embodiments, the internal security reputation factors of DEFINE ONE OR MORE SECURITY REPUTATION FACTORS OPERATION 203 include, but are not limited to, data indicating the party's history of Internet access from the organization's equipment. In one embodiment, the party's use of organizational equipment, such as computing systems, to access the Internet is taken into consideration, including whether the Internet access is deemed to be in connection with the party's role within the organization or of a more personal nature. In various embodiments, a determination that the party is using organizational equipment to access the Internet for personal reasons is considered a potential problem.

In various embodiments, the internal security reputation factors of DEFINE ONE OR MORE SECURITY REPUTATION FACTORS OPERATION 203 include, but are not limited to, data indicating the party's history of Internet access during the party's working hours. In various embodiments, a determination that the party is accessing the Internet for personal reasons during working hours is considered a potential problem.

In various embodiments, the internal security reputation factors of DEFINE ONE OR MORE SECURITY REPUTATION FACTORS OPERATION 203 include, but are not limited to, data indicating the party's history of cloud-based resources access using the organization's equipment. In various embodiments, a determination that the party is using organizational equipment to access the cloud for non-project related reasons is considered a potential problem.

In various embodiments, the internal security reputation factors of DEFINE ONE OR MORE SECURITY REPUTATION FACTORS OPERATION 203 include, but are not limited to, data indicating the party's history of cloud-based resources access during the party's working hours. In various embodiments, log data indicating the party's use of cloud-based resources is monitored to ensure the party is using the cloud-based resources only for tasks associated with the party's role during working hours.

In various embodiments, the internal security reputation factors of DEFINE ONE OR MORE SECURITY REPUTATION FACTORS OPERATION 203 include, but are not limited to, data indicating the party's history of cloud-based resources access during the party's non-working hours. In various embodiments, log data indicating the party's use of cloud-based resources is monitored to ensure the party is not accessing the cloud during non-working hours.

In various embodiments, the internal security reputation factors of DEFINE ONE OR MORE SECURITY REPUTATION FACTORS OPERATION 203 include, but are not limited to, data indicating the party's compliance with one or more employment policies. As an example, in one embodiment, data is obtained indicating whether the party turns off computing systems used by the party at the end of the workday, and/or whether the party complies with various organizational security policies.

In various embodiments, the security reputation factors of DEFINE ONE OR MORE SECURITY REPUTATION FACTORS OPERATION 203 include, but are not limited to, consideration of external security reputation factors obtained by monitoring the party's activities and interaction with resources outside the organization, and/or associated with third party entities.

In various embodiments, the external security reputation factors of DEFINE ONE OR MORE SECURITY REPUTATION FACTORS OPERATION 203 include, but are not limited to, data obtained from one or more external websites associated with the party, and/or data obtained from one or more accounts with one or more social media websites associated with the party.

In various embodiments, as a condition for being provided employment, and/or access and permissions data, the party is required to provide the organization permission to access, and/or access information related to, various websites, including social media websites, where the party may have an account, and/or presence. In various embodiments, these external websites are monitored to ensure that the party's activities outside of the workplace are in compliance with the organization's security and employment policies. Any indication from the party's presence on the outside websites that the party is engaging in, or supporting, activities that are contrary to the organization's security and/or employment policies is considered problematic.

In various embodiments, as a condition for being provided employment and/or permissions data, the party is requested to provide various information required to access the various external websites. In one embodiment, failure to provide this data, or update this data when it is changed, is considered problematic. In addition, failure to provide the required access data, and/or update the required access data, upon request is also considered problematic. In various embodiments, even when the party fails to provide the required access data, other methods may be employed to obtain the data such as, but not limited to, screen scraping or similar technologies.

In various embodiments, the external security reputation factors of DEFINE ONE OR MORE SECURITY REPUTATION FACTORS OPERATION 203 include, but are not limited to, data obtained from a web browser used by the party indicating the party's Internet access history and sites accessed by the party using organizational equipment, and/or equipment that is used for organizational access. In various embodiments, data indicating that the party is accessing websites that are considered problematic, and/or contrary to the organization's security and/or employment policy, is considered problematic.

In various embodiments, the external security reputation factors of DEFINE ONE OR MORE SECURITY REPUTATION FACTORS OPERATION 203 include, but are not limited to, historical geographic location data associated with the party. In various embodiments, computing systems, and particularly mobile computing systems, phones, or other devices, associated with the party, and/or as provided to the party by the organization, are used to track the travel and geographic locations associated with a party. In various embodiments, data indicating that the party has traveled to, or frequents, geographic locations associated with businesses and/or organizations that are considered problematic, such as a competitor of the organization's offices, and/or known geographic locations associated with malicious actors, is considered an indication of the trust level associated with the party.

In various embodiments, the external security reputation factors of DEFINE ONE OR MORE SECURITY REPUTATION FACTORS OPERATION 203 include, but are not limited to, data obtained from one or more phones associated with the party, such as data indicating phone numbers, text messages, and/or emails, sent, and/or received, by the party. In various embodiments, this data is analyzed to determine if the party is in contact with other parties and/or organizations considered problematic, and/or contrary to, the organization's security and/or employment policies.

In various embodiments, the external security reputation factors of DEFINE ONE OR MORE SECURITY REPUTATION FACTORS OPERATION 203 include, but are not limited to, data obtained from one or more computing systems associated with the party. In various embodiments, this data is analyzed to determine if the party is in contact with other parties and/or organizations considered problematic, and/or contrary to the organization's security and/or employment policies.

In various embodiments, the security reputation factors of DEFINE ONE OR MORE SECURITY REPUTATION FACTORS OPERATION 203 include, but are not limited to, consideration of human resources security reputation factors indicating the party's employment and advancement record within the organization.

In various embodiments, the human resources security reputation factors of DEFINE ONE OR MORE SECURITY REPUTATION FACTORS OPERATION 203 include, but are not limited to, the length of employment of the party by the organization. In various embodiments, the longer the party has been an employee of, and/or associated with, the organization; the higher the level of trust assigned to the party.

In various embodiments, the human resources security reputation factors of DEFINE ONE OR MORE SECURITY REPUTATION FACTORS OPERATION 203 include, but are not limited to, data indicating the advancement of the party within the organization as compared with similarly situated parties within the organization. In various embodiments, data indicating the party has not advanced within the organization at the same rate as other similarly situated parties within the organization is considered potentially problematic in that this data could be an indication that the party is not particularly happy in their position. Consequently data indicating the party has not advanced at the same rate as other similarly situated parties can be an indication that the trust assigned to the party should be lowered.

In various embodiments, the human resources security reputation factors include, but are not limited to, data reflecting employee review/evaluation data associated with the party. In various embodiments, a poor, or lower than historical, review or evaluation of the party is considered potentially problematic and an indication that the trust of the party should be lowered. Likewise, a good, or higher than historical, review or evaluation of the party is considered an indication that the trust of the party should be raised.

In various embodiments, the human resources security reputation factors of DEFINE ONE OR MORE SECURITY REPUTATION FACTORS OPERATION 203 include, but are not limited to, the employment history of the party. In particular, data indicating the party has been employed by competitors of the organization, and/or has been subjected to disciplinary action within the organization, and/or by previous employers, is considered potentially problematic and an indication that the trust assigned to the party should be lower.

In various embodiments, the security reputation factors of DEFINE ONE OR MORE SECURITY REPUTATION FACTORS OPERATION 203 can include any security reputation factors, or combination of security reputation factors, as discussed herein, and/or as known in the art at the time of filing, and/or as become known, or are made available, after the time of filing.

In one embodiment, once one or more security reputation factors are defined and/or determined at DEFINE ONE OR MORE SECURITY REPUTATION FACTORS OPERATION 203, process flow proceeds to OBTAIN SECURITY REPUTATION DATA ASSOCIATED WITH A PARTY; THE SECURITY REPUTATION DATA ASSOCIATED WITH THE PARTY REPRESENTING THE PARTY'S ACTIVITIES WITH RESPECT TO THE ONE OR MORE SECURITY REPUTATION FACTORS OPERATION 205.

In one embodiment, at OBTAIN SECURITY REPUTATION DATA ASSOCIATED WITH A PARTY; THE SECURITY REPUTATION DATA ASSOCIATED WITH THE PARTY REPRESENTING THE PARTY'S ACTIVITIES WITH RESPECT TO THE ONE OR MORE SECURITY REPUTATION FACTORS OPERATION 205, security reputation data associated with a given party is obtained.

In one embodiment, the security reputation data associated with a given party of OBTAIN SECURITY REPUTATION DATA ASSOCIATED WITH A PARTY; THE SECURITY REPUTATION DATA ASSOCIATED WITH THE PARTY REPRESENTING THE PARTY'S ACTIVITIES WITH RESPECT TO THE ONE OR MORE SECURITY REPUTATION FACTORS OPERATION 205 represents the party's activities with respect to the one or more security reputation factors of DEFINE ONE OR MORE SECURITY REPUTATION FACTORS OPERATION 203.

In various embodiments, the security reputation data associated with the party of OBTAIN SECURITY REPUTATION DATA ASSOCIATED WITH A PARTY; THE SECURITY REPUTATION DATA ASSOCIATED WITH THE PARTY REPRESENTING THE PARTY'S ACTIVITIES WITH RESPECT TO THE ONE OR MORE SECURITY REPUTATION FACTORS OPERATION 205 includes security reputation data obtained from several sources including, but not limited to, log data representing historical access used by the party, and/or one or more members of a team or project supervised by the party; employment records for the party, and/or one or more members of a team or project supervised by the party; a human resources department and/or an accounting department associated with the organization; by monitoring the activities and interaction with resources within, and/or with, the organization of the party, and/or one or more members of a team or project supervised by the party; by monitoring the activities and interaction with resources outside the organization, and/or associated with third party entities, of the party, and/or one or more members of a team or project supervised by the party; log data indicating use and management of secrets data and adherence to security procedures by party, and/or one or more members of a team or project supervised by the party; one or more external websites associated with the party, and/or one or more members of a team or project supervised by the party; one or more social media websites associated with the party, and/or one or more members of a team or project supervised by the party; a web browser used by the party, and/or one or more members of a team or project supervised by the party, indicating Internet access history and sites accessed by the party, and/or one or more members of a team or project supervised by the party, using organizational equipment, and/or equipment that is used for organizational access; one or more phones associated with the party, and/or one or more members of a team or project supervised by the party, such as data indicating phone numbers, text messages, and/or emails, sent, and/or received, by the party, and/or one or more members of a team or project supervised by the party; one or more computing systems associated with the party, and/or one or more members of a team or project supervised by the party; financial data associated with the party, and/or one or more members of a team or project supervised by the party, obtained from public and/or private sources; the party, and/or one or more members of a team or project supervised by the party, via one or more forms and or questionnaires, and/or verbally; and/or from any other source of security reputation data, and using any other methods for obtaining security reputation data, as discussed herein, and/or as known in the art at the time of filing, and/or as becomes known after the time of filing.

In various embodiments, the security reputation data associated with the party is not only initially obtained at OBTAIN SECURITY REPUTATION DATA ASSOCIATED WITH A PARTY; THE SECURITY REPUTATION DATA ASSOCIATED WITH THE PARTY REPRESENTING THE PARTY'S ACTIVITIES WITH RESPECT TO THE ONE OR MORE SECURITY REPUTATION FACTORS OPERATION 205, but the security reputation data associated with the party is automatically monitored on a periodic, event driven, and/or relatively continuous basis.

In one embodiment, once security reputation data associated with a given party is obtained at OBTAIN SECURITY REPUTATION DATA ASSOCIATED WITH A PARTY; THE SECURITY REPUTATION DATA ASSOCIATED WITH THE PARTY REPRESENTING THE PARTY'S ACTIVITIES WITH RESPECT TO THE ONE OR MORE SECURITY REPUTATION FACTORS OPERATION 205, process flow proceeds to USE THE SECURITY REPUTATION DATA ASSOCIATED WITH THE PARTY TO CALCULATE A SECURITY REPUTATION SCORE TO BE ASSOCIATED WITH THE PARTY OPERATION 207.

In one embodiment, at USE THE SECURITY REPUTATION DATA ASSOCIATED WITH THE PARTY TO CALCULATE A SECURITY REPUTATION SCORE TO BE ASSOCIATED WITH THE PARTY OPERATION 207, the security reputation data associated with the party of OBTAIN SECURITY REPUTATION DATA ASSOCIATED WITH A PARTY; THE SECURITY REPUTATION DATA ASSOCIATED WITH THE PARTY REPRESENTING THE PARTY'S ACTIVITIES WITH RESPECT TO THE ONE OR MORE SECURITY REPUTATION FACTORS OPERATION 205 is processed to generate a security reputation score for the party.

In one embodiment, data representing the party's activities with respect to each of the defined security reputation factors of DEFINE ONE OR MORE SECURITY REPUTATION FACTORS OPERATION 203 included in the security reputation data associated with the party of OBTAIN SECURITY REPUTATION DATA ASSOCIATED WITH A PARTY; THE SECURITY REPUTATION DATA ASSOCIATED WITH THE PARTY REPRESENTING THE PARTY'S ACTIVITIES WITH RESPECT TO THE ONE OR MORE SECURITY REPUTATION FACTORS OPERATION 205 is individually weighted and processed to generate a security reputation score for the party according to one more algorithms and/or instructions included in one or more memories and implemented by one or more processors associated with one or more computing systems.

In one embodiment, once calculated, the security reputation score for the party of USE THE SECURITY REPUTATION DATA ASSOCIATED WITH THE PARTY TO CALCULATE A SECURITY REPUTATION SCORE TO BE ASSOCIATED WITH THE PARTY OPERATION 207 is associated with the party in one or more records or databases so that the security reputation score of USE THE SECURITY REPUTATION DATA ASSOCIATED WITH THE PARTY TO CALCULATE A SECURITY REPUTATION SCORE TO BE ASSOCIATED WITH THE PARTY OPERATION 207 is associated with the party throughout the organization and regardless of any particular project or job description currently assigned to the party. In one embodiment, at USE THE SECURITY REPUTATION DATA ASSOCIATED WITH THE PARTY TO CALCULATE A SECURITY REPUTATION SCORE TO BE ASSOCIATED WITH THE PARTY OPERATION 207 a security reputation score is calculated for all, or any sub-set, of the employees of the organization.

In one embodiment, the security reputation score associated with the party of USE THE SECURITY REPUTATION DATA ASSOCIATED WITH THE PARTY TO CALCULATE A SECURITY REPUTATION SCORE TO BE ASSOCIATED WITH THE PARTY OPERATION 207 becomes part of that party's employment record. In one embodiment, the security reputation score associated with the party of USE THE SECURITY REPUTATION DATA ASSOCIATED WITH THE PARTY TO CALCULATE A SECURITY REPUTATION SCORE TO BE ASSOCIATED WITH THE PARTY OPERATION 207 is used by various supervisors within the organization to determine the eligibility of the party to work on a particular project or to be advanced to a particular job description. In one embodiment, the security reputation score associated with the party of USE THE SECURITY REPUTATION DATA ASSOCIATED WITH THE PARTY TO CALCULATE A SECURITY REPUTATION SCORE TO BE ASSOCIATED WITH THE PARTY OPERATION 207 is used as a metric for determining the party's advancement, and/or as an employee evaluation tool.

In one embodiment, at USE THE SECURITY REPUTATION DATA ASSOCIATED WITH THE PARTY TO CALCULATE A SECURITY REPUTATION SCORE TO BE ASSOCIATED WITH THE PARTY OPERATION 207 the security reputation data of OBTAIN SECURITY REPUTATION DATA ASSOCIATED WITH A PARTY; THE SECURITY REPUTATION DATA ASSOCIATED WITH THE PARTY REPRESENTING THE PARTY'S ACTIVITIES WITH RESPECT TO THE ONE OR MORE SECURITY REPUTATION FACTORS OPERATION 205 is processed to generate a security reputation score to be associated with the party by a security reputation access control engine used to generate security reputation scores and/or determine access and permissions data to be provided to the party.

In one embodiment, once the security reputation data associated with the party of OBTAIN SECURITY REPUTATION DATA ASSOCIATED WITH A PARTY; THE SECURITY REPUTATION DATA ASSOCIATED WITH THE PARTY REPRESENTING THE PARTY'S ACTIVITIES WITH RESPECT TO THE ONE OR MORE SECURITY REPUTATION FACTORS OPERATION 205 is processed to generate a security reputation score for the party at USE THE SECURITY REPUTATION DATA ASSOCIATED WITH THE PARTY TO CALCULATE A SECURITY REPUTATION SCORE TO BE ASSOCIATED WITH THE PARTY OPERATION 207, process flow proceeds to USE THE SECURITY REPUTATION SCORE ASSOCIATED WITH THE PARTY TO DETERMINE WHAT ACCESS TO ONE OR MORE RESOURCES PROVIDED BY AN ORGANIZATION ASSOCIATED WITH THE PARTY SHOULD BE PROVIDED TO THE PARTY OPERATION 209.

In one embodiment, at USE THE SECURITY REPUTATION SCORE ASSOCIATED WITH THE PARTY TO DETERMINE WHAT ACCESS TO ONE OR MORE RESOURCES PROVIDED BY AN ORGANIZATION ASSOCIATED WITH THE PARTY SHOULD BE PROVIDED TO THE PARTY OPERATION 209, the security reputation score associated with the party of USE THE SECURITY REPUTATION DATA ASSOCIATED WITH THE PARTY TO CALCULATE A SECURITY REPUTATION SCORE TO BE ASSOCIATED WITH THE PARTY OPERATION 207 is used to determine access and permissions allowed for the party. As noted above, in various embodiments, the access and permissions allowed for the party of USE THE SECURITY REPUTATION SCORE ASSOCIATED WITH THE PARTY TO DETERMINE WHAT ACCESS TO ONE OR MORE RESOURCES PROVIDED BY AN ORGANIZATION ASSOCIATED WITH THE PARTY SHOULD BE PROVIDED TO THE PARTY OPERATION 209 determined by the security reputation score associated with the party of USE THE SECURITY REPUTATION DATA ASSOCIATED WITH THE PARTY TO CALCULATE A SECURITY REPUTATION SCORE TO BE ASSOCIATED WITH THE PARTY OPERATION 207 includes data providing the party with access to one or more resources.

In various embodiments, the access and permissions allowed for the party of USE THE SECURITY REPUTATION SCORE ASSOCIATED WITH THE PARTY TO DETERMINE WHAT ACCESS TO ONE OR MORE RESOURCES PROVIDED BY AN ORGANIZATION ASSOCIATED WITH THE PARTY SHOULD BE PROVIDED TO THE PARTY OPERATION 209 determined by the security reputation score associated with the party of USE THE SECURITY REPUTATION DATA ASSOCIATED WITH THE PARTY TO CALCULATE A SECURITY REPUTATION SCORE TO BE ASSOCIATED WITH THE PARTY OPERATION 207 includes access to one or more accounts which, in turn, provide access to one or more resources.

In various embodiments, the access and permissions allowed for the party of USE THE SECURITY REPUTATION SCORE ASSOCIATED WITH THE PARTY TO DETERMINE WHAT ACCESS TO ONE OR MORE RESOURCES PROVIDED BY AN ORGANIZATION ASSOCIATED WITH THE PARTY SHOULD BE PROVIDED TO THE PARTY OPERATION 209 determined by the security reputation score associated with the party of USE THE SECURITY REPUTATION DATA ASSOCIATED WITH THE PARTY TO CALCULATE A SECURITY REPUTATION SCORE TO BE ASSOCIATED WITH THE PARTY OPERATION 207 includes one or more accounts which, in turn, provide access to one or more virtual assets and/or other resources within a cloud computing environment.

In various embodiments, the access and permissions allowed for the party of USE THE SECURITY REPUTATION SCORE ASSOCIATED WITH THE PARTY TO DETERMINE WHAT ACCESS TO ONE OR MORE RESOURCES PROVIDED BY AN ORGANIZATION ASSOCIATED WITH THE PARTY SHOULD BE PROVIDED TO THE PARTY OPERATION 209 determined by the security reputation score associated with the party of USE THE SECURITY REPUTATION DATA ASSOCIATED WITH THE PARTY TO CALCULATE A SECURITY REPUTATION SCORE TO BE ASSOCIATED WITH THE PARTY OPERATION 207 includes one or more accounts which, in turn, provide the party the capability to instantiate, and/or boot-up, one or more instances and/or other virtual assets in a cloud computing environment.

In various embodiments, the access and permissions allowed for the party of USE THE SECURITY REPUTATION SCORE ASSOCIATED WITH THE PARTY TO DETERMINE WHAT ACCESS TO ONE OR MORE RESOURCES PROVIDED BY AN ORGANIZATION ASSOCIATED WITH THE PARTY SHOULD BE PROVIDED TO THE PARTY OPERATION 209 determined by the security reputation score associated with the party of USE THE SECURITY REPUTATION DATA ASSOCIATED WITH THE PARTY TO CALCULATE A SECURITY REPUTATION SCORE TO BE ASSOCIATED WITH THE PARTY OPERATION 207 includes secrets data required to access one or more resources.

In one embodiment, once the security reputation score associated with the party of USE THE SECURITY REPUTATION DATA ASSOCIATED WITH THE PARTY TO CALCULATE A SECURITY REPUTATION SCORE TO BE ASSOCIATED WITH THE PARTY OPERATION 207 is used to determine access and permissions allowed for the party at USE THE SECURITY REPUTATION SCORE ASSOCIATED WITH THE PARTY TO DETERMINE WHAT ACCESS TO ONE OR MORE RESOURCES PROVIDED BY AN ORGANIZATION ASSOCIATED WITH THE PARTY SHOULD BE PROVIDED TO THE PARTY OPERATION 209, process flow proceeds to RECOMMEND THE PARTY BE PROVIDED THE DETERMINED ACCESS TO ONE OR MORE RESOURCES OPERATION 211.

In one embodiment, at RECOMMEND THE PARTY BE PROVIDED THE DETERMINED ACCESS TO ONE OR MORE RESOURCES OPERATION 211, the security reputation score associated with the party of USE THE SECURITY REPUTATION DATA ASSOCIATED WITH THE PARTY TO CALCULATE A SECURITY REPUTATION SCORE TO BE ASSOCIATED WITH THE PARTY OPERATION 207 is used to make a recommendation as to which access rights and/or permissions data should be provided to the party, as determined at USE THE SECURITY REPUTATION SCORE ASSOCIATED WITH THE PARTY TO DETERMINE WHAT ACCESS TO ONE OR MORE RESOURCES PROVIDED BY AN ORGANIZATION ASSOCIATED WITH THE PARTY SHOULD BE PROVIDED TO THE PARTY OPERATION 209.

In one embodiment, the security reputation score associated with the party is used to make a recommendation at RECOMMEND THE PARTY BE PROVIDED THE DETERMINED ACCESS TO ONE OR MORE RESOURCES OPERATION 211 as to whether an individual access request made by the party should be granted on a case-by-case basis in response to the received individual access request made by the party.

In one embodiment, the security reputation score associated with the party is used to make a recommendation at RECOMMEND THE PARTY BE PROVIDED THE DETERMINED ACCESS TO ONE OR MORE RESOURCES OPERATION 211 regarding a set of allowed access and permissions data to be provided to, and associated with, the party; the set of allowed access and permissions data providing the party access to one or more resources.

In one embodiment, the security reputation score associated with the party is calculated and analyzed at RECOMMEND THE PARTY BE PROVIDED THE DETERMINED ACCESS TO ONE OR MORE RESOURCES OPERATION 211 to recommend specific access, and/or a set of allowed access and permissions data to be associated with the party, at regularly scheduled time intervals. For instance, in various embodiments, on a weekly, monthly, quarterly, or annual basis, and/or at any other time interval defined and/or desired.

In one embodiment, the security reputation score associated with the party is calculated and analyzed at RECOMMEND THE PARTY BE PROVIDED THE DETERMINED ACCESS TO ONE OR MORE RESOURCES OPERATION 211 to recommend specific access, and/or a set of allowed access and permissions data to be associated with the party, after each job or project change, evaluation, and/or review, of the party, and/or upon the transfer of the party, and/or upon promotion or demotion of the party.

In one embodiment, the security reputation score associated with the party is calculated and analyzed at RECOMMEND THE PARTY BE PROVIDED THE DETERMINED ACCESS TO ONE OR MORE RESOURCES OPERATION 211 to recommend specific access, and/or a set of allowed access and permissions data to be associated with the party, whenever there is a threshold change in any of the security reputation data associated with the party.

In one embodiment, once the security reputation score associated with the party of USE THE SECURITY REPUTATION DATA ASSOCIATED WITH THE PARTY TO CALCULATE A SECURITY REPUTATION SCORE TO BE ASSOCIATED WITH THE PARTY OPERATION 207 is used to make a recommendation as to which access rights and/or permissions data should be provided to the party, as determined at USE THE SECURITY REPUTATION SCORE ASSOCIATED WITH THE PARTY TO DETERMINE WHAT ACCESS TO ONE OR MORE RESOURCES PROVIDED BY AN ORGANIZATION ASSOCIATED WITH THE PARTY SHOULD BE PROVIDED TO THE PARTY OPERATION 209 at RECOMMEND THE PARTY BE PROVIDED THE DETERMINED ACCESS TO ONE OR MORE RESOURCES OPERATION 211, process flow proceeds to EXIT OPERATION 230.

In one embodiment, at EXIT OPERATION 230 process 200 for access control management using reputation scores is exited to await new data.

Using process 200 for access control management using reputation scores, actual security reputation data associated with a party is used to calculate a security reputation score to be associated with the party. The security reputation score associated with the party is then associated with that party within the organization regardless of any specific project the party is associated with, or any specific activity within a given project assigned to the party. The security reputation score associated with the party is then used to make a recommendation as to which access rights and/or permissions data should be provided to the party without the need to involve senior management and with little or no wait time.

Consequently, using process 200 for access control management using reputation scores, the security reputation of parties associated with an organization is objectively and systematically determined and then used to automate the assignment of access rights and permissions data provided to a party, and/or make recommendations regarding the access rights and permissions data provided to the party.

In another, more automated, embodiment, once the set of allowed access permissions data for the party is obtained/retrieved, the set of allowed access permissions data for the party is automatically provided to the party, e.g., is provided to an access system, and/or account, associated with the party, without any further approval or input.

In accordance with one embodiment, a method and system for access control management using reputation scores includes defining one or more security reputation factors to be monitored that are indicative of a party's security related history and activities. In one embodiment, security reputation data associated with a party which represents the party's activities with respect to the one or more security reputation factors is automatically monitored and obtained.

In one embodiment, the security reputation data associated with the party is then used to automatically calculate a security reputation score to be associated with the party and the security reputation score associated with the party is used to automatically provide the party access to one or more resources provided by an organization associated with the party.

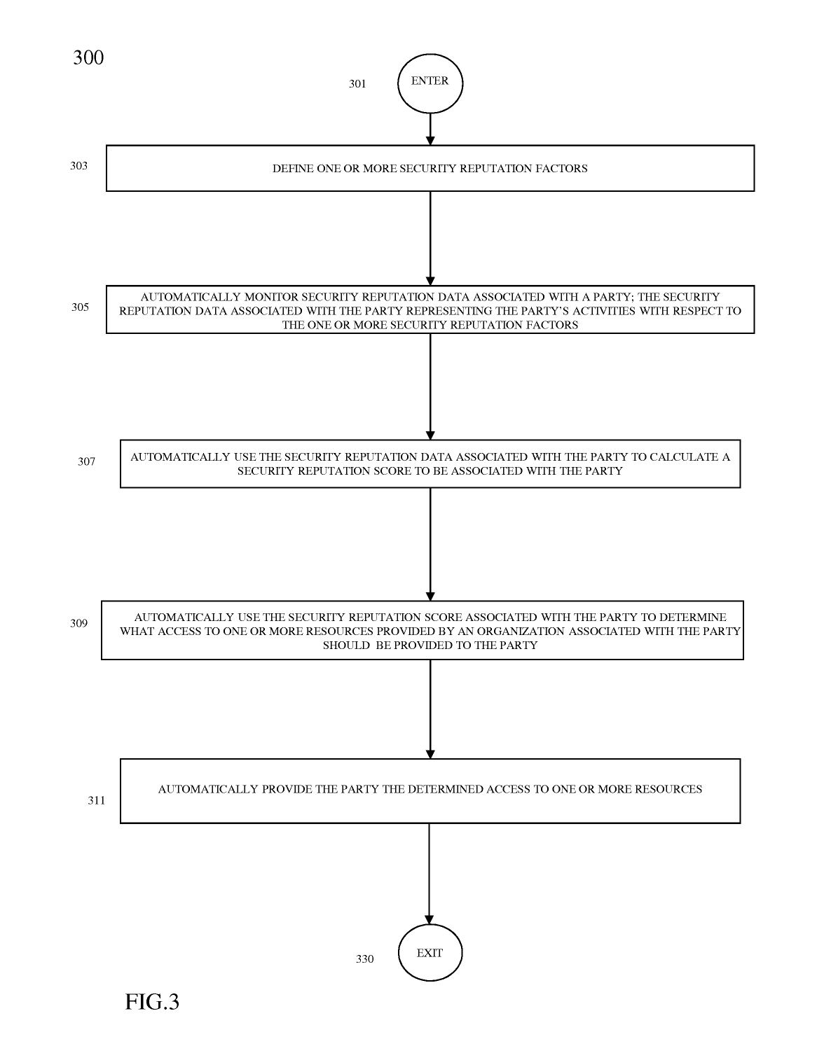

FIG. 3 is a flow chart of a process 300 for access control management using reputation scores in accordance with one embodiment. In one embodiment, process 300 for access control management using reputation scores begins at ENTER OPERATION 301 of FIG. 3 and process flow proceeds to DEFINE ONE OR MORE SECURITY REPUTATION FACTORS OPERATION 303.

In one embodiment, at DEFINE ONE OR MORE SECURITY REPUTATION FACTORS OPERATION 303, one or more security reputation factors are defined and/or determined. In one embodiment, the one or more security reputation factors defined and/or determined at DEFINE ONE OR MORE SECURITY REPUTATION FACTORS OPERATION 303 include any, or all, of the security reputation factors discussed above with respect to DEFINE ONE OR MORE SECURITY REPUTATION FACTORS OPERATION 203 of process 200 for access control management using reputation scores and FIG. 2.

Returning to FIG. 3, in one embodiment, once one or more security reputation factors are defined and/or determined at DEFINE ONE OR MORE SECURITY REPUTATION FACTORS OPERATION 303, process flow proceeds to AUTOMATICALLY MONITOR SECURITY REPUTATION DATA ASSOCIATED WITH A PARTY; THE SECURITY REPUTATION DATA ASSOCIATED WITH THE PARTY REPRESENTING THE PARTY'S ACTIVITIES WITH RESPECT TO THE ONE OR MORE SECURITY REPUTATION FACTORS OPERATION 305.

In one embodiment, at AUTOMATICALLY MONITOR SECURITY REPUTATION DATA ASSOCIATED WITH A PARTY; THE SECURITY REPUTATION DATA ASSOCIATED WITH THE PARTY REPRESENTING THE PARTY'S ACTIVITIES WITH RESPECT TO THE ONE OR MORE SECURITY REPUTATION FACTORS OPERATION 305, security reputation data associated with a given party is automatically obtained.

In one embodiment, the security reputation data associated with a given party of AUTOMATICALLY MONITOR SECURITY REPUTATION DATA ASSOCIATED WITH A PARTY; THE SECURITY REPUTATION DATA ASSOCIATED WITH THE PARTY REPRESENTING THE PARTY'S ACTIVITIES WITH RESPECT TO THE ONE OR MORE SECURITY REPUTATION FACTORS OPERATION 305 represents the party's activities with respect to the one or more security reputation factors of DEFINE ONE OR MORE SECURITY REPUTATION FACTORS OPERATION 303.

In various embodiments, the security reputation data associated with the party of AUTOMATICALLY MONITOR SECURITY REPUTATION DATA ASSOCIATED WITH A PARTY; THE SECURITY REPUTATION DATA ASSOCIATED WITH THE PARTY REPRESENTING THE PARTY'S ACTIVITIES WITH RESPECT TO THE ONE OR MORE SECURITY REPUTATION FACTORS OPERATION 305 includes security reputation data automatically obtained from several sources including, but not limited to, log data representing historical access used by the party, and/or one or more members of a team or project supervised by the party; employment records for the party, and/or one or more members of a team or project supervised by the party; a human resources department and/or an accounting department associated with the organization; by monitoring the activities and interaction with resources within, and/or with, the organization of the party, and/or one or more members of a team or project supervised by the party; by monitoring the activities and interaction with resources outside the organization, and/or associated with third party entities, of the party, and/or one or more members of a team or project supervised by the party; log data indicating use and management of secrets data and adherence to security procedures by party, and/or one or more members of a team or project supervised by the party; one or more external websites associated with the party, and/or one or more members of a team or project supervised by the party; one or more social media websites associated with the party, and/or one or more members of a team or project supervised by the party; a web browser used by the party, and/or one or more members of a team or project supervised by the party, indicating Internet access history and sites accessed by the party, and/or one or more members of a team or project supervised by the party, using organizational equipment, and/or equipment that is used for organizational access; one or more phones associated with the party, and/or one or more members of a team or project supervised by the party, such as data indicating phone numbers, text messages, and/or emails, sent, and/or received, by the party, and/or one or more members of a team or project supervised by the party; one or more computing systems associated with the party, and/or one or more members of a team or project supervised by the party; financial data associated with the party, and/or one or more members of a team or project supervised by the party, obtained from public and/or private sources; the party, and/or one or more members of a team or project supervised by the party, via one or more forms and or questionnaires, and/or verbally; and/or from any other source of security reputation data, and using any other methods for obtaining security reputation data, as discussed herein, and/or as known in the art at the time of filing, and/or as becomes known after the time of filing.

In various embodiments, the security reputation data associated with the party is not only initially automatically obtained at AUTOMATICALLY MONITOR SECURITY REPUTATION DATA ASSOCIATED WITH A PARTY; THE SECURITY REPUTATION DATA ASSOCIATED WITH THE PARTY REPRESENTING THE PARTY'S ACTIVITIES WITH RESPECT TO THE ONE OR MORE SECURITY REPUTATION FACTORS OPERATION 305, but the security reputation data associated with the party is automatically monitored on a periodic, event driven, and/or relatively continuous basis.

In one embodiment, once security reputation data associated with a given party is automatically obtained at AUTOMATICALLY MONITOR SECURITY REPUTATION DATA ASSOCIATED WITH A PARTY; THE SECURITY REPUTATION DATA ASSOCIATED WITH THE PARTY REPRESENTING THE PARTY'S ACTIVITIES WITH RESPECT TO THE ONE OR MORE SECURITY REPUTATION FACTORS OPERATION 305, process flow proceeds to AUTOMATICALLY USE THE SECURITY REPUTATION DATA ASSOCIATED WITH THE PARTY TO CALCULATE A SECURITY REPUTATION SCORE TO BE ASSOCIATED WITH THE PARTY OPERATION 307.

In one embodiment, at AUTOMATICALLY USE THE SECURITY REPUTATION DATA ASSOCIATED WITH THE PARTY TO CALCULATE A SECURITY REPUTATION SCORE TO BE ASSOCIATED WITH THE PARTY OPERATION 307, the security reputation data associated with the party of AUTOMATICALLY MONITOR SECURITY REPUTATION DATA ASSOCIATED WITH A PARTY; THE SECURITY REPUTATION DATA ASSOCIATED WITH THE PARTY REPRESENTING THE PARTY'S ACTIVITIES WITH RESPECT TO THE ONE OR MORE SECURITY REPUTATION FACTORS OPERATION 305 is automatically processed to generate a security reputation score for the party.

In one embodiment, data representing the party's activities with respect to each of the defined security reputation factors of DEFINE ONE OR MORE SECURITY REPUTATION FACTORS OPERATION 303 included in the security reputation data associated with the party of AUTOMATICALLY MONITOR SECURITY REPUTATION DATA ASSOCIATED WITH A PARTY; THE SECURITY REPUTATION DATA ASSOCIATED WITH THE PARTY REPRESENTING THE PARTY'S ACTIVITIES WITH RESPECT TO THE ONE OR MORE SECURITY REPUTATION FACTORS OPERATION 305 is automatically individually weighted and processed to automatically generate a security reputation score for the party according to one more algorithms and/or instructions included in one or more memories and implemented by one or more processors associated with one or more computing systems.

In one embodiment, once calculated, the security reputation score for the party of AUTOMATICALLY USE THE SECURITY REPUTATION DATA ASSOCIATED WITH THE PARTY TO CALCULATE A SECURITY REPUTATION SCORE TO BE ASSOCIATED WITH THE PARTY OPERATION 307 is automatically associated with the party in one or more records or databases so that the security reputation score of AUTOMATICALLY USE THE SECURITY REPUTATION DATA ASSOCIATED WITH THE PARTY TO CALCULATE A SECURITY REPUTATION SCORE TO BE ASSOCIATED WITH THE PARTY OPERATION 307 is automatically associated with the party throughout the organization and regardless of any particular project or job description currently assigned to the party. In one embodiment, at AUTOMATICALLY USE THE SECURITY REPUTATION DATA ASSOCIATED WITH THE PARTY TO CALCULATE A SECURITY REPUTATION SCORE TO BE ASSOCIATED WITH THE PARTY OPERATION 307 a security reputation score is automatically calculated for all, or any sub-set, of the employees of the organization.

In one embodiment, the security reputation score associated with the party of AUTOMATICALLY USE THE SECURITY REPUTATION DATA ASSOCIATED WITH THE PARTY TO CALCULATE A SECURITY REPUTATION SCORE TO BE ASSOCIATED WITH THE PARTY OPERATION 307 automatically becomes part of that party's employment record. In one embodiment, the security reputation score associated with the party of AUTOMATICALLY USE THE SECURITY REPUTATION DATA ASSOCIATED WITH THE PARTY TO CALCULATE A SECURITY REPUTATION SCORE TO BE ASSOCIATED WITH THE PARTY OPERATION 307 is used by various supervisors within the organization to determine the eligibility of the party to work on a particular project or to be advanced to a particular job description. In one embodiment, the security reputation score associated with the party of AUTOMATICALLY USE THE SECURITY REPUTATION DATA ASSOCIATED WITH THE PARTY TO CALCULATE A SECURITY REPUTATION SCORE TO BE ASSOCIATED WITH THE PARTY OPERATION 307 is used as a metric for determining the party's advancement, and/or as an employee evaluation tool.

In one embodiment, at AUTOMATICALLY USE THE SECURITY REPUTATION DATA ASSOCIATED WITH THE PARTY TO CALCULATE A SECURITY REPUTATION SCORE TO BE ASSOCIATED WITH THE PARTY OPERATION 307 the security reputation data of AUTOMATICALLY MONITOR SECURITY REPUTATION DATA ASSOCIATED WITH A PARTY; THE SECURITY REPUTATION DATA ASSOCIATED WITH THE PARTY REPRESENTING THE PARTY'S ACTIVITIES WITH RESPECT TO THE ONE OR MORE SECURITY REPUTATION FACTORS OPERATION 305 is automatically processed to generate a security reputation score to be associated with the party by a security reputation access control engine used to generate security reputation scores and/or determine access and permissions data to be provided to the party.

In one embodiment, once the security reputation data associated with the party of AUTOMATICALLY MONITOR SECURITY REPUTATION DATA ASSOCIATED WITH A PARTY; THE SECURITY REPUTATION DATA ASSOCIATED WITH THE PARTY REPRESENTING THE PARTY'S ACTIVITIES WITH RESPECT TO THE ONE OR MORE SECURITY REPUTATION FACTORS OPERATION 305 is automatically processed to generate a security reputation score for the party at AUTOMATICALLY USE THE SECURITY REPUTATION DATA ASSOCIATED WITH THE PARTY TO CALCULATE A SECURITY REPUTATION SCORE TO BE ASSOCIATED WITH THE PARTY OPERATION 307, process flow proceeds to AUTOMATICALLY USE THE SECURITY REPUTATION SCORE ASSOCIATED WITH THE PARTY TO DETERMINE WHAT ACCESS TO ONE OR MORE RESOURCES PROVIDED BY AN ORGANIZATION ASSOCIATED WITH THE PARTY SHOULD BE PROVIDED TO THE PARTY OPERATION 309.

In one embodiment, at AUTOMATICALLY USE THE SECURITY REPUTATION SCORE ASSOCIATED WITH THE PARTY TO DETERMINE WHAT ACCESS TO ONE OR MORE RESOURCES PROVIDED BY AN ORGANIZATION ASSOCIATED WITH THE PARTY SHOULD BE PROVIDED TO THE PARTY OPERATION 309, the security reputation score associated with the party of AUTOMATICALLY USE THE SECURITY REPUTATION DATA ASSOCIATED WITH THE PARTY TO CALCULATE A SECURITY REPUTATION SCORE TO BE ASSOCIATED WITH THE PARTY OPERATION 307 is automatically used to determine access and permissions allowed for the party.

As noted above, in various embodiments, the access and permissions allowed for the party of AUTOMATICALLY USE THE SECURITY REPUTATION SCORE ASSOCIATED WITH THE PARTY TO DETERMINE WHAT ACCESS TO ONE OR MORE RESOURCES PROVIDED BY AN ORGANIZATION ASSOCIATED WITH THE PARTY SHOULD BE PROVIDED TO THE PARTY OPERATION 309 automatically determined by the security reputation score associated with the party of AUTOMATICALLY USE THE SECURITY REPUTATION DATA ASSOCIATED WITH THE PARTY TO CALCULATE A SECURITY REPUTATION SCORE TO BE ASSOCIATED WITH THE PARTY OPERATION 307 includes data providing the party with access to one or more resources.

In various embodiments, the access and permissions allowed for the party of AUTOMATICALLY USE THE SECURITY REPUTATION SCORE ASSOCIATED WITH THE PARTY TO DETERMINE WHAT ACCESS TO ONE OR MORE RESOURCES PROVIDED BY AN ORGANIZATION ASSOCIATED WITH THE PARTY SHOULD BE PROVIDED TO THE PARTY OPERATION 309 automatically determined by the security reputation score associated with the party of AUTOMATICALLY USE THE SECURITY REPUTATION DATA ASSOCIATED WITH THE PARTY TO CALCULATE A SECURITY REPUTATION SCORE TO BE ASSOCIATED WITH THE PARTY OPERATION 307 includes access to one or more accounts which, in turn, provide access to one or more resources.

In various embodiments, the access and permissions allowed for the party of AUTOMATICALLY USE THE SECURITY REPUTATION SCORE ASSOCIATED WITH THE PARTY TO DETERMINE WHAT ACCESS TO ONE OR MORE RESOURCES PROVIDED BY AN ORGANIZATION ASSOCIATED WITH THE PARTY SHOULD BE PROVIDED TO THE PARTY OPERATION 309 automatically determined by the security reputation score associated with the party of AUTOMATICALLY USE THE SECURITY REPUTATION DATA ASSOCIATED WITH THE PARTY TO CALCULATE A SECURITY REPUTATION SCORE TO BE ASSOCIATED WITH THE PARTY OPERATION 307 includes one or more accounts which, in turn, provide access to one or more virtual assets and/or other resources within a cloud computing environment.

In various embodiments, the access and permissions allowed for the party of AUTOMATICALLY USE THE SECURITY REPUTATION SCORE ASSOCIATED WITH THE PARTY TO DETERMINE WHAT ACCESS TO ONE OR MORE RESOURCES PROVIDED BY AN ORGANIZATION ASSOCIATED WITH THE PARTY SHOULD BE PROVIDED TO THE PARTY OPERATION 309 automatically determined by the security reputation score associated with the party of AUTOMATICALLY USE THE SECURITY REPUTATION DATA ASSOCIATED WITH THE PARTY TO CALCULATE A SECURITY REPUTATION SCORE TO BE ASSOCIATED WITH THE PARTY OPERATION 307 includes one or more accounts which, in turn, provide the party the capability to instantiate, and/or boot-up, one or more instances and/or other virtual assets in a cloud computing environment.

In various embodiments, the access and permissions allowed for the party of AUTOMATICALLY USE THE SECURITY REPUTATION SCORE ASSOCIATED WITH THE PARTY TO DETERMINE WHAT ACCESS TO ONE OR MORE RESOURCES PROVIDED BY AN ORGANIZATION ASSOCIATED WITH THE PARTY SHOULD BE PROVIDED TO THE PARTY OPERATION 309 automatically determined by the security reputation score associated with the party of AUTOMATICALLY USE THE SECURITY REPUTATION DATA ASSOCIATED WITH THE PARTY TO CALCULATE A SECURITY REPUTATION SCORE TO BE ASSOCIATED WITH THE PARTY OPERATION 307 includes secrets data required to access one or more resources.

In one embodiment, once the security reputation score associated with the party of AUTOMATICALLY USE THE SECURITY REPUTATION DATA ASSOCIATED WITH THE PARTY TO CALCULATE A SECURITY REPUTATION SCORE TO BE ASSOCIATED WITH THE PARTY OPERATION 307 is automatically used to determine access and permissions allowed for the party at AUTOMATICALLY USE THE SECURITY REPUTATION SCORE ASSOCIATED WITH THE PARTY TO DETERMINE WHAT ACCESS TO ONE OR MORE RESOURCES PROVIDED BY AN ORGANIZATION ASSOCIATED WITH THE PARTY SHOULD BE PROVIDED TO THE PARTY OPERATION 309, process flow proceeds to AUTOMATICALLY PROVIDE THE PARTY THE DETERMINED ACCESS TO ONE OR MORE RESOURCES OPERATION 311.

In one embodiment, at AUTOMATICALLY PROVIDE THE PARTY THE DETERMINED ACCESS TO ONE OR MORE RESOURCES OPERATION 311, the security reputation score associated with the party of AUTOMATICALLY USE THE SECURITY REPUTATION DATA ASSOCIATED WITH THE PARTY TO CALCULATE A SECURITY REPUTATION SCORE TO BE ASSOCIATED WITH THE PARTY OPERATION 307 is used to automatically provide the set of allowed access permissions data for the party of USE THE SECURITY REPUTATION SCORE ASSOCIATED WITH THE PARTY TO DETERMINE WHAT ACCESS TO ONE OR MORE RESOURCES PROVIDED BY AN ORGANIZATION ASSOCIATED WITH THE PARTY SHOULD BE PROVIDED TO THE PARTY OPERATION 309 to the party, e.g., provide the set of allowed access permissions data for the party of USE THE SECURITY REPUTATION SCORE ASSOCIATED WITH THE PARTY TO DETERMINE WHAT ACCESS TO ONE OR MORE RESOURCES PROVIDED BY AN ORGANIZATION ASSOCIATED WITH THE PARTY SHOULD BE PROVIDED TO THE PARTY OPERATION 309 to an access system, and/or account, associated with the party, without any further approval or input.

In one embodiment, at AUTOMATICALLY PROVIDE THE PARTY THE DETERMINED ACCESS TO ONE OR MORE RESOURCES OPERATION 311, the security reputation score associated with the party of AUTOMATICALLY USE THE SECURITY REPUTATION DATA ASSOCIATED WITH THE PARTY TO CALCULATE A SECURITY REPUTATION SCORE TO BE ASSOCIATED WITH THE PARTY OPERATION 307 is used to automatically determine whether an individual access request made by the party should be granted on a case-by-case basis in response to the received individual access request made by the party.

In one embodiment, at AUTOMATICALLY PROVIDE THE PARTY THE DETERMINED ACCESS TO ONE OR MORE RESOURCES OPERATION 311, the security reputation score associated with the party of AUTOMATICALLY USE THE SECURITY REPUTATION DATA ASSOCIATED WITH THE PARTY TO CALCULATE A SECURITY REPUTATION SCORE TO BE ASSOCIATED WITH THE PARTY OPERATION 307 is used to automatically provide, and associate, a set of allowed access and permissions data with the party; the set of allowed access and permissions data providing the party access to one or more resources.

In one embodiment, at AUTOMATICALLY PROVIDE THE PARTY THE DETERMINED ACCESS TO ONE OR MORE RESOURCES OPERATION 311, the security reputation score associated with the party of AUTOMATICALLY USE THE SECURITY REPUTATION DATA ASSOCIATED WITH THE PARTY TO CALCULATE A SECURITY REPUTATION SCORE TO BE ASSOCIATED WITH THE PARTY OPERATION 307 is automatically calculated and analyzed to automatically provide specific access, and/or a set of allowed access and permissions data to be associated with the party, at regularly scheduled time intervals. For instance, in various embodiments, on a weekly, monthly, quarterly, or annual basis, and/or at any other time interval defined and/or desired.

In one embodiment, at AUTOMATICALLY PROVIDE THE PARTY THE DETERMINED ACCESS TO ONE OR MORE RESOURCES OPERATION 311, the security reputation score associated with the party of AUTOMATICALLY USE THE SECURITY REPUTATION DATA ASSOCIATED WITH THE PARTY TO CALCULATE A SECURITY REPUTATION SCORE TO BE ASSOCIATED WITH THE PARTY OPERATION 307 is automatically calculated and analyzed to automatically provide specific access, and/or a set of allowed access and permissions data to be associated with the party, after each job or project change, evaluation and/or review, of the party, and/or upon the transfer of the party, and/or upon promotion or demotion of the party.

In one embodiment, at AUTOMATICALLY PROVIDE THE PARTY THE DETERMINED ACCESS TO ONE OR MORE RESOURCES OPERATION 311, the security reputation score associated with the party of AUTOMATICALLY USE THE SECURITY REPUTATION DATA ASSOCIATED WITH THE PARTY TO CALCULATE A SECURITY REPUTATION SCORE TO BE ASSOCIATED WITH THE PARTY OPERATION 307 is automatically calculated and analyzed to automatically provide specific access, and/or a set of allowed access and permissions data to be associated with the party, whenever there is a threshold change in any of the security reputation data associated with the party.

In another, even more automated, embodiment, if the party requests access to a resource for which the party does not currently have the required access and permissions data, the security reputation score associated with the party is automatically analyzed to determine if the party should be provided the required access and permissions data, and if a determination is made that the party should be provided the required access and permissions data, the party is automatically provided the required access and permissions data. This analysis and provision of access and permissions data based on the security reputation score associated with the party represents a level of automation requiring little or no organizational input beyond establishing the initial operating parameters.

In one embodiment, once the security reputation score associated with the party of AUTOMATICALLY USE THE SECURITY REPUTATION DATA ASSOCIATED WITH THE PARTY TO CALCULATE A SECURITY REPUTATION SCORE TO BE ASSOCIATED WITH THE PARTY OPERATION 307 is used to automatically provide the set of allowed access permissions data for the party of USE THE SECURITY REPUTATION SCORE ASSOCIATED WITH THE PARTY TO DETERMINE WHAT ACCESS TO ONE OR MORE RESOURCES PROVIDED BY AN ORGANIZATION ASSOCIATED WITH THE PARTY SHOULD BE PROVIDED TO THE PARTY OPERATION 309 to the party, e.g., provide the set of allowed access permissions data for the party of USE THE SECURITY REPUTATION SCORE ASSOCIATED WITH THE PARTY TO DETERMINE WHAT ACCESS TO ONE OR MORE RESOURCES PROVIDED BY AN ORGANIZATION ASSOCIATED WITH THE PARTY SHOULD BE PROVIDED TO THE PARTY OPERATION 309 to an access system, and/or account, associated with the party, without any further approval or input at AUTOMATICALLY PROVIDE THE PARTY THE DETERMINED ACCESS TO ONE OR MORE RESOURCES OPERATION 311, process flow proceeds to EXIT OPERATION 330.

In one embodiment, at EXIT OPERATION 330 process 300 for access control management using reputation scores is exited to await new data.

Using process 300 for access control management using reputation scores, actual security reputation data associated with a party is used to calculate a security reputation score to be associated with the party. The security reputation score associated with the party is then associated with that party within the organization regardless of any specific project the party is associated with, or any specific activity within a given project assigned to the party. The security reputation score associated with the party is then used to automatically provided access rights and/or permissions data to the party without the need to involve senior management and with little or no wait time.

Consequently, using process 300 for access control management using reputation scores, the security reputation of parties associated with an organization is objectively and systematically determined and then used to automate the assignment of access rights and permissions data provided to a party, and/or make recommendations regarding the access rights and permissions data provided to the party.

In the discussion above, certain aspects of one embodiment include process steps and/or operations and/or instructions described herein for illustrative purposes in a particular order and/or grouping. However, the particular order and/or grouping shown and discussed herein are illustrative only and not limiting. Those of skill in the art will recognize that other orders and/or grouping of the process steps and/or operations and/or instructions are possible and, in some embodiments, one or more of the process steps and/or operations and/or instructions discussed above can be combined and/or deleted. In addition, portions of one or more of the process steps and/or operations and/or instructions can be re-grouped as portions of one or more other of the process steps and/or operations and/or instructions discussed herein. Consequently, the particular order and/or grouping of the process steps and/or operations and/or instructions discussed herein do not limit the scope of the invention as claimed below.

As discussed in more detail above, using the above embodiments, with little or no modification and/or input, there is considerable flexibility, adaptability, and opportunity for customization to meet the specific needs of various parties under numerous circumstances.

The present invention has been described in particular detail with respect to specific possible embodiments. Those of skill in the art will appreciate that the invention may be practiced in other embodiments. For example, the nomenclature used for components, capitalization of component designations and terms, the attributes, data structures, or any other programming or structural aspect is not significant, mandatory, or limiting, and the mechanisms that implement the invention or its features can have various different names, formats, or protocols. Further, the system or functionality of the invention may be implemented via various combinations of software and hardware, as described, or entirely in hardware elements. Also, particular divisions of functionality between the various components described herein are merely exemplary, and not mandatory or significant. Consequently, functions performed by a single component may, in other embodiments, be performed by multiple components, and functions performed by multiple components may, in other embodiments, be performed by a single component.

Some portions of the above description present the features of the present invention in terms of algorithms and symbolic representations of operations, or algorithm-like representations, of operations on information/data. These algorithmic or algorithm-like descriptions and representations are the means used by those of skill in the art to most effectively and efficiently convey the substance of their work to others of skill in the art. These operations, while described functionally or logically, are understood to be implemented by computer programs or computing systems. Furthermore, it has also proven convenient at times to refer to these arrangements of operations as steps or modules or by functional names, without loss of generality.

Unless specifically stated otherwise, as would be apparent from the above discussion, it is appreciated that throughout the above description, discussions utilizing terms such as, but not limited to, “activating”, “accessing”, “aggregating”, “alerting”, “applying”, “analyzing”, “associating”, “calculating”, “capturing”, “categorizing”, “classifying”, “comparing”, “creating”, “defining”, “detecting”, “determining”, “distributing”, “encrypting”, “extracting”, “filtering”, “forwarding”, “generating”, “identifying”, “implementing”, “informing”, “monitoring”, “obtaining”, “posting”, “processing”, “providing”, “receiving”, “requesting”, “saving”, “sending”, “storing”, “transferring”, “transforming”, “transmitting”, “using”, etc., refer to the action and process of a computing system or similar electronic device that manipulates and operates on data represented as physical (electronic) quantities within the computing system memories, resisters, caches or other information storage, transmission or display devices.

The present invention also relates to an apparatus or system for performing the operations described herein. This apparatus or system may be specifically constructed for the required purposes, or the apparatus or system can comprise a general purpose system selectively activated or configured/reconfigured by a computer program stored on a computer program product as discussed herein that can be accessed by a computing system or other device.

Those of skill in the art will readily recognize that the algorithms and operations presented herein are not inherently related to any particular computing system, computer architecture, computer or industry standard, or any other specific apparatus. Various general purpose systems may also be used with programs in accordance with the teaching herein, or it may prove more convenient/efficient to construct more specialized apparatuses to perform the required operations described herein. The required structure for a variety of these systems will be apparent to those of skill in the art, along with equivalent variations. In addition, the present invention is not described with reference to any particular programming language and it is appreciated that a variety of programming languages may be used to implement the teachings of the present invention as described herein, and any references to a specific language or languages are provided for illustrative purposes only.

The present invention is well suited to a wide variety of computer network systems operating over numerous topologies. Within this field, the configuration and management of large networks comprise storage devices and computers that are communicatively coupled to similar or dissimilar computers and storage devices over a private network, a LAN, a WAN, a private network, or a public network, such as the Internet.

It should also be noted that the language used in the specification has been principally selected for readability, clarity and instructional purposes, and may not have been selected to delineate or circumscribe the inventive subject matter. Accordingly, the disclosure of the present invention is intended to be illustrative, but not limiting, of the scope of the invention, which is set forth in the claims below.

In addition, the operations shown in the FIG.s, or as discussed herein, are identified using a particular nomenclature for ease of description and understanding, but other nomenclature is often used in the art to identify equivalent operations.

Therefore, numerous variations, whether explicitly provided for by the specification or implied by the specification or not, may be implemented by one of skill in the art in view of this disclosure.

What is claimed is:

1. A system for access control management using reputation scores comprising:
at least one processor; and
at least one memory coupled to the at least one processor, the at least one memory having stored therein instructions which when executed by any set of the one or more processors, perform a process for access control management using reputation scores, the process for access control management using reputation scores including:
defining one or more security reputation factors;
obtaining and monitoring security reputation data associated with a party, the security reputation data associated with the party representing the party's activities with respect to the one or more security reputation factors;
processing the security reputation data associated with the party to calculate a security reputation score to be associated with the party; and
using the security reputation score associated with the party to determine what access to one or more resources provided by an organization associated with the party will be provided to the party.

2. The system for access control management using reputation scores of claim 1 wherein at least one of the one or more security reputation factors includes a security reputation factor selected from the group of security reputation factors consisting of:
the party's historical use of access to one or more resources provided to the party;
the security integrity of code generated by the party;
the security integrity of code previously generated under the supervision of the party;
the party's historical use and management of secrets data and adherence to security procedures promulgated by the organization;
the historical use and management of secrets data and adherence to security procedures promulgated by the organization by entities under the supervision of the party;
the security history associated with various hardware and software systems used by the party;
the party's current level of access;
the record of security events involving the party;
the record of security events involving entities supervised by the party;
the record of security events involving systems used by, accessible, or associated with, the party;
the party's record of reporting security events associated with the party;
the party's use of static analysis tools to check code and systems created by the party;
the party's use of static analysis tools to check code and systems created under the supervision of the party;
the types of vulnerabilities in code and systems created by the party discovered by static analysis tools;
the party's historic response to vulnerabilities in code and systems created by the party discovered by static analysis tools;
the strength of passwords used by the party;
if the passwords used by the party conform to a password policy of the organization;
how often the party changes/rotates their passwords;
whether the passwords used by the party are changed/rotated in accordance with a password policy of the organization;
the responsiveness of the party to requests for data and/or action by the party with respect to security;
internal security reputation factors obtained by monitoring the party's activities and interaction with resources within, and/or with, the organization;
external security reputation factors obtained by monitoring the party's activities and interaction with resources outside the organization, and/or associated with third party entities;
human resources security reputation factors indicating the party's employment and advancement record within the organization;
security certifications that the party has;
security education of the party; and
any combination thereof.

3. The system for access control management using reputation scores of claim 2 wherein at least one of the internal security reputation factors includes an internal security reputation factor selected from the group of internal security reputation factors consisting of:
the party's history of attempted access to resources for which the party did not have the required permissions;
the party's history of Internet access from the organization's equipment;
the party's history of Internet access during the party's working hours;
the party's history of cloud-based resources access using the organization's equipment;
the party's history of cloud-based resources access during the party's working hours;
the party's history of cloud-based resources access during the party's non-working hours;
the party's compliance with one or more employment policies; and
any combination thereof.

4. The system for access control management using reputation scores of claim 2 wherein at least one of the external security reputation factors includes an external security reputation factor selected from the group of external security reputation factors consisting of:
data obtained from one or more external websites associated with the party;
data obtained from one or more accounts with one or more social media websites associated with the party;
data obtained from a web browser used by the party;
historical geographic locations data associated with the party;
data obtained from one or more phones associated with the party;
data obtained from one or more computing systems associated with the party; and
any combination thereof.

5. The system for access control management using reputation scores of claim 2 wherein at least one of the external security reputation factors includes data associated with the party obtained from one or more social media websites.

6. The system for access control management using reputation scores of claim 2 wherein at least part of the human resources security reputation factors includes human resources security reputation factors selected from the group of human resources security reputation factors consisting of:
the length of employment of the party by the organization;
the advancement of the party within the organization as compared with similarly situated parties within the organization;
employee review/evaluation data associated with the party;
the employment history of the party; and
any combination thereof.

7. The system for access control management using reputation scores of claim 1 wherein the security reputation score associated with the party is used to determine whether an individual access request made by the party will be granted.

8. The system for access control management using reputation scores of claim 1 wherein the security reputation score associated with the party is used to determine a set of allowed access permissions to be provided to party.

9. The system for access control management using reputation scores of claim 1 wherein the security reputation score associated with the party is used to determine what teams or projects the party can work with.

10. The system for access control management using reputation scores of claim 1 wherein the security reputation score associated with the party is calculated at periodic intervals.

11. The system for access control management using reputation scores of claim 1 wherein the security reputation score associated with the party is used to determine the set of allowed access permissions to be provided to party whenever there is a defined threshold change in the security reputation data associated with the party.

12. The system for access control management using reputation scores of claim 1 wherein the access to one or more resources provided by an organization associated with the party determined by the security reputation score associated with the party includes instantiation, and/or boot-up, access associated with one or more virtual assets.

13. The system for access control management using reputation scores of claim 1 wherein the access to one or more resources provided by an organization associated with the party determined by the security reputation score associated with the party includes the use of one or more accounts assigned to the organization associated with one or more resources.

14. The system for access control management using reputation scores of claim 1 wherein the one or more resources are selected from the group of resources consisting of:
a virtual machine;
a virtual server;
a database or data store;
an instance in a cloud environment;
a cloud environment access system;
part of a mobile device;
part of a remote sensor;
part of a laptop computing system;
part of a desktop computing system;
part of a point-of-sale computing system; and
part of an ATM.

15. The system for access control management using reputation scores of claim 1 wherein the access to one or more resources provided by an organization associated with the party determined by the security reputation score associated with the party includes providing the party secrets data required to access one or more resources.

16. A system for access control management using reputation scores comprising:
one or more resources assigned to an organization;
a permissions database, the permissions database including one or more sets of permissions data, each of the one or more sets of permissions data providing access to associated ones of the one or more resources assigned to an organization;
a security reputation database, the security reputation database including security reputation data associated with a party, the security reputation data associated with the party representing the party's activities with respect to the one or more defined security reputation factors;
a security reputation access control engine;
at least one processor; and
at least one memory coupled to the at least one processor, the at least one memory having stored therein instructions which when executed by any set of the one or more processors, perform a process for access control management using reputation scores, the process for access control management using reputation scores including:
providing the security reputation data associated with the party to the security reputation access control engine;
the security reputation access control engine processing the security reputation data associated with the party to calculate a security reputation score to be associated with the party; and
the security reputation access control engine using the security reputation score associated with the party to determine which of the one or more sets of permissions data should be provided to the party.

17. The system for access control management using reputation scores of claim 16 wherein at least one of the one or more security reputation factors includes a security reputation factor selected from the group of security reputation factors consisting of:
the party's historical use of access to one or more resources provided to the party;
the security integrity of code generated by the party;
the security integrity of code previously generated under the supervision of the party;
the party's historical use and management of secrets data and adherence to security procedures promulgated by the organization;
the historical use and management of secrets data and adherence to security procedures promulgated by the organization by entities under the supervision of the party;
the security history associated with various hardware and software systems used by the party;
the party's current level of access;
the record of security events involving the party;
the record of security events involving entities supervised by the party;
the record of security events involving systems used by, accessible, or associated with, the party;
the party's record of reporting security events associated with the party;
the party's use of static analysis tools to check code and systems created by the party;
the party's use of static analysis tools to check code and systems created under the supervision of the party;
the types of vulnerabilities in code and systems created by the party discovered by static analysis tools;
the party's historic response to vulnerabilities in code and systems created by the party discovered by static analysis tools;
the strength of passwords used by the party;
if the passwords used by the party conform to a password policy of the organization;
how often the party changes/rotates their passwords;
whether the passwords used by the party are changed/rotated in accordance with a password policy of the organization;
the responsiveness of the party to requests for data and/or action by the party with respect to security;
internal security reputation factors obtained by monitoring the party's activities and interaction with resources within, and/or with, the organization;
external security reputation factors obtained by monitoring the party's activities and interaction with resources outside the organization, and/or associated with third party entities;
human resources security reputation factors indicating the party's employment and advancement record within the organization;
security certifications that the party has;
security education of the party; and
any combination thereof.

18. The system for access control management using reputation scores of claim 17 wherein at least one of the internal security reputation factors includes an internal security reputation factor selected from the group of internal security reputation factors consisting of:
the party's history of attempted access to resources for which the party did not have the required permissions;
the party's history of Internet access from the organization's equipment;
the party's history of Internet access during the party's working hours;
the party's history of cloud-based resources access using the organization's equipment;
the party's history of cloud-based resources access during the party's working hours;
the party's history of cloud-based resources access during the party's non-working hours;
the party's compliance with one or more employment policies; and
any combination thereof.

19. The system for access control management using reputation scores of claim 17 wherein at least one of the external security reputation factors includes an external security reputation factor selected from the group of external security reputation factors consisting of:
data obtained from one or more external websites associated with the party;
data obtained from one or more accounts with one or more social media websites associated with the party;
data obtained from a web browser used by the party;
historical geographic locations data associated with the party;
data obtained from one or more phones associated with the party;
data obtained from one or more computing systems associated with the party; and
any combination thereof.

20. The system for access control management using reputation scores of claim 17 wherein at least part of the human resources security reputation factors includes human resources security reputation factors selected from the group of human resources security reputation factors consisting of:
the length of employment of the party by the organization;
the advancement of the party within the organization as compared with similarly situated parties within the organization;
employee review/evaluation data associated with the party;
the employment history of the party; and
any combination thereof.

21. The system for access control management using reputation scores of claim 17 wherein the security reputation score associated with the party is used to determine what teams or projects the party can work with.

22. The system for access control management using reputation scores of claim 16 wherein the security reputation score associated with the party is calculated by the security reputation access control engine at periodic intervals.

23. The system for access control management using reputation scores of claim 16 wherein the security reputation score associated with the party is used to determine the set of allowed access permissions to be provided to party whenever there is a defined threshold change in the security reputation data associated with the party.

24. The system for access control management using reputation scores of claim 16 wherein at least one of the one or more sets of permissions data provides instantiation, and/or boot-up, permission associated with one or more virtual assets.

25. The system for access control management using reputation scores of claim 16 wherein at least one of the one or more sets of permissions data allows use of one or more accounts assigned to the organization associated with one or more resources.

26. The system for access control management using reputation scores of claim 16 wherein the one or more resources are selected from the group of resources consisting of:
a virtual machine;
a virtual server;
a database or data store;
an instance in a cloud environment;
a cloud environment access system;
part of a mobile device;
part of a remote sensor;
part of a laptop computing system;
part of a desktop computing system;
part of a point-of-sale computing system; and
part of an ATM.

27. The system for access control management using reputation scores of claim 16 wherein at least one of the one or more sets of permissions data includes secrets data required to access one or more resources.

28. A method for access control management comprising:
defining one or more security reputation factors;
obtaining and monitoring security reputation data associated with a party, the security reputation data associated with the party representing the party's activities with respect to the one or more security reputation factors;
processing the security reputation data associated with the party to calculate a security reputation score to be associated with the party; and
using the security reputation score associated with the party to determine what access to one or more resources provided by an organization associated with the party will be provided to the party.

29. The method for access control management using reputation scores of claim 28 wherein at least one of the one or more security reputation factors includes a security reputation factor selected from the group of security reputation factors consisting of:
the party's historical use of access to one or more resources provided to the party;
the security integrity of code generated by the party;
the security integrity of code previously generated under the supervision of the party;
the party's historical use and management of secrets data and adherence to security procedures promulgated by the organization;
the historical use and management of secrets data and adherence to security procedures promulgated by the organization by entities under the supervision of the party;
the security history associated with various hardware and software systems used by the party;
the party's current level of access;
the record of security events involving the party;
the record of security events involving entities supervised by the party;
the record of security events involving systems used by, accessible, or associated with, the party;
the party's record of reporting security events associated with the party;
the party's use of static analysis tools to check code and systems created by the party;
the party's use of static analysis tools to check code and systems created under the supervision of the party;
the types of vulnerabilities in code and systems created by the party discovered by static analysis tools;
the party's historic response to vulnerabilities in code and systems created by the party discovered by static analysis tools;
the strength of passwords used by the party;
if the passwords used by the party conform to a password policy of the organization;
how often the party changes/rotates their passwords;
whether the passwords used by the party are changed/rotated in accordance with a password policy of the organization;
the responsiveness of the party to requests for data and/or action by the party with respect to security;
security certifications that the party has;
security education of the party;
internal security reputation factors obtained by monitoring the party's activities and interaction with resources within, and/or with, the organization;
external security reputation factors obtained by monitoring the party's activities and interaction with resources outside the organization, and/or associated with third party entities;
human resources security reputation factors indicating the party's employment and advancement record within the organization; and
any combination thereof.

30. The method for access control management using reputation scores of claim 29 wherein at least one of the internal security reputation factors includes an internal security reputation factor selected from the group of internal security reputation factors consisting of:
the party's history of attempted access to resources for which the party did not have the required permissions;
the party's history of Internet access from the organization's equipment;
the party's history of Internet access during the party's working hours;
the party's history of cloud-based resources access using the organization's equipment;
the party's history of cloud-based resources access during the party's working hours;
the party's history of cloud-based resources access during the party's non-working hours;
the party's compliance with one or more employment policies; and
any combination thereof.

31. The method for access control management using reputation scores of claim 29 wherein at least one of the external security reputation factors includes an external security reputation factor selected from the group of external security reputation factors consisting of:
data obtained from one or more external websites associated with the party;
data obtained from one or more accounts with one or more social media websites associated with the party;
data obtained from a web browser used by the party;
historical geographic locations data associated with the party;
data obtained from one or more phones associated with the party;
data obtained from one or more computing systems associated with the party; and
any combination thereof.

32. The method for access control management using reputation scores of claim 29 wherein at least one of the external security reputation factors includes data associated with the party obtained from one or more social media websites.

33. The method for access control management using reputation scores of claim 29 wherein at least part of the human resources security reputation factors includes human resources security reputation factors selected from the group of human resources security reputation factors consisting of:
the length of employment of the party by the organization;
the advancement of the party within the organization as compared with similarly situated parties within the organization;
employee review/evaluation data associated with the party;
the employment history of the party; and
any combination thereof.

34. The method for access control management using reputation scores of claim 28 wherein the security reputation score associated with the party is used to determine whether an individual access request made by the party will be granted.

35. The method for access control management using reputation scores of claim 28 wherein the security reputation score associated with the party is used to determine a set of allowed access permissions to be provided to party.

36. The method for access control management using reputation scores of claim 28 wherein the security reputation score associated with the party is used to determine what teams or projects the party can work with.

37. The method for access control management using reputation scores of claim 28 wherein the security reputation score associated with the party is calculated at periodic intervals.

38. The method for access control management using reputation scores of claim 28 wherein the security reputation score associated with the party is used to determine the set of allowed access permissions to be provided to party whenever there is a defined threshold change in the security reputation data associated with the party.

39. The method for access control management using reputation scores of claim 28 wherein the access to one or more resources provided by an organization associated with the party determined by the security reputation score associated with the party includes instantiation, and/or boot-up, access associated with one or more virtual assets.

40. The method for access control management using reputation scores of claim 28 wherein the access to one or more resources provided by an organization associated with the party determined by the security reputation score associated with the party includes the use of one or more accounts assigned to the organization associated with one or more resources.

41. The method for access control management using reputation scores of claim 28 wherein the one or more resources are selected from the group of resources consisting of:
a virtual machine;
a virtual server;
a database or data store;
an instance in a cloud environment;
a cloud environment access system;
part of a mobile device;
part of a remote sensor;
part of a laptop computing system;
part of a desktop computing system;
part of a point-of-sale computing system; and
part of an ATM.

42. The method for access control management using reputation scores of claim 28 wherein the access to one or more resources provided by an organization associated with the party determined by the security reputation score associated with the party includes providing the party secrets data required to access one or more resources.
